(19) United States
(12) Patent Application Publication
(10) Pub. No.: US 2019/0293572 A1
(43) Pub. Date: Sep. 26, 2019

(54) METHOS, SYSTEM AND COMPUTER PROGRAM PRODUCT FOR GENERATING A TWO DIMENSIONAL FOG MAP FROM CELLULAR COMMUNICATION NETWORK INFORMATION

(71) Applicant: RAMOT AT TEL-AVIV UNIVERSITY LTD., Tel Aviv (IL)

(72) Inventors: Noam DAVID, Petach Tikva (IL); Ori Cohen, Tel Aviv (IL); Pinhas Alpert, Moshav Beit Gamliel (IL); Hagit Messer-Yaron, Kfar Saba (IL)

(21) Appl. No.: 15/925,798

(22) Filed: Mar. 20, 2018

(51) Int. Cl. G01N 22/04; G06T 11/20; G01W 1/00

(52) U.S. Cl. CPC G01N 22/04; G01W 1/00; G06T 11/206

(57) ABSTRACT

A computerized method for generating a two-dimensional fog map of a region from a near-ground sensors network of commercial microwave links (CMLs), the region is virtually segmented to a grid of multiple pixels, the method comprises: collecting received signals levels from the CMLs, deriving the links' attenuation that are spread within multiple pixels of the region; calculating the fog induced attenuation attribute for each pixel out of a plurality of pixels of the region based on the microwave attenuation information and deciding if exists; wherein the plurality of pixels belong to the multiple pixels; and generating the two-dimensional fog map of the region based, at least in part, on the plurality of microwave attenuation attributes and the topography of the region; improving the 2-D fog map using information from other types of sensors, if exist.

### RELATED APPLICATION

This application claims priority from U.S. provisional patent Ser. No. 62/474,724 filing date 22 Mar. 2017.

### BACKGROUND

Fog

Fog is defined as water droplets suspended in the atmosphere in the vicinity of the earth's surface that reduces visibility below 1 km.

The current condition of the soil and its characteristics significantly affect the formation of fog and its evolution. The influence of the topography on the fog can be direct, as it affects wind speed and direction, local circulations, temperature and moisture. This effect may also be indirect since it can, for example, modify the atmospheric radiative characteristics via microphysical processes.

Visibility reduction due to fog depends on various elements including the concentration of cloud condensation nuclei and the resulting distribution of droplet size.

Fog Monitoring

Today, common fog monitoring instruments include local visibility sensors, transmissometers and human observers that provide visibility estimates based on the disappearance or appearance of objects at known distances. Due to practical considerations and the high costs involved, though, these tools are only deployed in specific locations of interest, such as: airfields, or meteorological stations. As a result, clearly, it is not possible to map fog widely across large areas using these tools. Satellite systems that observe the phenomenon from space provide fog observations with large spatial resolution, but they too suffer from difficulties in achieving reliable mapping. By definition, fog is a ground level phenomenon, and thus, high or medium altitude clouds, which lie above the fog, but below the satellite, may occlude the phenomenon from the satellite's point of view thus restricting the ability to detect the fog in certain areas. Conversely, the satellite may mistake a low-lying stratus cloud, that is, in fact, at elevation (e.g. a few tens of meters above ground) for fog.

Some fog Monitoring Methods are listed below.

Human Observers

A trained human observer assesses visibility by the appearance or occlusion of object at known distances from the observer present location. However, the assessments is subjective judgment by a particular observer, one observer's estimation might disagree with another's when assessing the same visibility condition.

Transmissometers

One of the most common instruments for measuring the light extinction coefficients is the transmissometer. Transmissometers include a light source, such as a laser, and a detector for detecting either light from the light source directly or light from the light source that is reflected back to the detector from a reflector such as a mirror. The source emits a modulated flux of light with constant mean power while the receiving unit contains a photodetector to measure the light falling on it. This instrument measures the mean light extinction coefficient in a horizontal cylinder of air between the source and the receiver that can be located from a few meters to several hundreds of meters apart. Although this device is considered very accurate, its cost is extremely high. An additional technique includes instruments measuring the scatter coefficient. Both scattering and absorption contribute to the atmospheric attenuation of light. The main contributor to reduced visibility is the scatter phenomena created by the water droplets, while the absorption factor is, in general, negligible. This being the case, measuring the scatter coefficient may be considered as equal to measuring the extinction coefficient. By concentrating a beam of light on a small volume of air, the proportion of light being scattered in sufficiently large angles and in non-critical directions can be determined through photometric means. However, this technique only allows for a small sample volume to be measured. As a result, the visibility representativeness obtained is limited.

Satellites

Satellites have the advantage of providing large spatial coverage. Nevertheless, in some cases, they struggle to supply fog detections at ground level. High or middle altitude clouds along the line of sight between the ground and the system may obscure ground level fog. It is also difficult to differentiate, using this technique, whether the observation reflects actual fog, or low stratus clouds, found at higher levels off the surface. In order to improve the fog detection method s additional spectral channels are needed.

In this work, we used data from METEOSAT second Generation (MSG) geostationary satellite using red-green-blue (RGB) composites of the computed physical value of the picture element using Clouds-Aerosols-Precipitation Satellite Analysis Tool (CAPSAT)

The physical values are the solar reflectance in the solar channels and brightness temperature in the thermal channels. The RGB composition used for fog representation is “Night Microphysical”, presenting clouds microstructure using the brightness temperature differences (BTD) between 10.8 and 3.9 μm.

The BTD between 10.8 and 3.9 μm channels (BTD_{10.8-3.9}) modulated the green beam in the “Night Microphysical” color scheme. Nighttime shallow clouds or fog with small drops appears in this color scheme in white.

The different RGB combination have relative advantage for observing different phenomena. “Night microphysical” is the most appropriate scheme for inferring cloud microstructure during night time.

Fog Monitoring Using Commercial Microwave Links

Cellular communication networks are constructed such that the geographic coverage of the network is divided into cells (hence the name). A caller connects to a nearby base station, and the call information is passed between cells in a backhaul network until it arrives at the cell of the end user being called. One mean of transferring data between cells is through the use of wireless links comprised of a transmitter on one end of the link, and a receiver on the other end. These wireless links operate at frequencies of tens of Gigahertz, a frequency range called microwave, and are affected by different hydrometeors in the atmosphere that attenuate the Received Signal Level (RSL) in the network. The microwave links (MWLs) are widely deployed close to ground level over a wide area, and are extremely common around the world. Thus, it is possible to use the existing networks for environmental monitoring—and there is an ability of the system to monitor rainfall. Other studies indicated the possibility of high resolution spatial and temporal mapping of rain. Additional hydrometeors induce attenuation on the system including atmospheric water vapor and dew, hence the potential for monitoring these phenomena using this new technology.

Recent works revealed the potential of these networks to monitor fog. They demonstrated the feasibility of detecting fog and estimating its intensity using dozens of commercial MWLs operating at the common frequency range of 37-39 GHz in a relatively compact given area. As the cellular technology advances, and in order to support the most advanced systems (such as smartphones), there is a growing demand for higher rates of data transfer in the network. To answer this demand, there is a trend of transitioning to and integrating links that operate at higher frequencies into the network. As a result, the potential sensitivity for fog monitoring, using future networks is higher. They also provided a simulation was carried out to evaluate the future potential of a backhaul network to monitor fog at high resolution. In order to show this potential, the paper also presented induced attenuation measurements for certain particular areas.

### SUMMARY

There may be provided a computerized method for generating a two-dimensional fog map of a region, the method may include (i) collecting measurements of received signals levels from commercial microwave links; wherein the measuring may be executed by a near-ground sensors network of the commercial microwave links, wherein the commercial microwave links are spread within multiple pixels of the region; (ii) deriving commercial microwave links attenuations from the received signals levels; (iii) deciding on an existence of fog within each pixel in which measurements exist based on (a) the commercial microwave links attenuations, and (b) a mapping between the commercial microwave links and the multiple pixels; and (iv) generating the two-dimensional fog map of the region based on the existence of fog within at least one pixel of the multiple pixels.

The generating of the two-dimensional fog map of the region may include interpolating information about the at least one pixel.

The generating of the two-dimensional fog map of the region may be further responsive to information obtained by one or more other sensors that differ from microwave links sensors.

There may be provided a computerized method for generating a two-dimensional fog map of a region, the method may include (i) extracting information about commercial microwave links attenuations from received signals levels of commercial microwave links; wherein the commercial microwave links are spread within multiple pixels of the region; (ii) deciding on an existence of fog within at least one pixel of the multiple pixels based on (a) the commercial microwave links attenuations, and (b) a mapping between the commercial microwave links and the multiple pixels; and (iii) generating the two-dimensional fog map of the region based on the existence of fog within at least one pixel of the multiple pixels.

The generating of the two-dimensional fog map of the region may include interpolating information about the at least one pixel.

The generating of the two-dimensional fog map of the region may be further responsive to information obtained by one or more other sensors that differ from microwave radiation sensors.

There may be provided a computerized method for generating a two-dimensional fog map of a region from a near-ground sensors network of commercial microwave links that are spread within multiple pixels of the region, the method may include (i) collecting the received signals levels of the commercial microwave links; (ii) deriving commercial microwave links attenuations from the received signals levels; (iii) deciding on an existence of fog within each of the multiple pixels based on (a) the commercial microwave links attenuations, and (b) a mapping between the commercial microwave links and the multiple pixels; and (iv) generating the two-dimensional fog map of the region by interpolating information about the at least one pixel.

The generating of the two-dimensional fog map of the region may be further responsive to information obtained by one or more other sensors that differ from microwave links.

There may be provided a computer program product that stores instructions that once executed by a computerized system cause the computerized system to execute the steps of (i) measuring received signals levels provided by commercial microwave links; wherein the measuring may be executed by a near-ground sensors network of the commercial microwave links, wherein the commercial microwave links are spread within multiple pixels of a region; (ii) deriving commercial microwave links attenuations from the received signals levels; (iii) deciding on an existence of fog within at least one pixel of the multiple pixels based on (a) the commercial microwave links attenuations, and (b) a mapping between the commercial microwave links and the multiple pixels; and (iv) generating a two-dimensional fog map of the region based on the existence of fog within at least one pixel of the multiple pixels.

The generating of the two-dimensional fog map of the region may include interpolating information about the at least one pixel.

The generating of the two-dimensional fog map of the region may be further responsive to information obtained by one or more other sensors that differ from microwave radiation sensors.

There may be provided a computer program product that stores instructions that once executed by a computerized system cause the computerized system to execute the steps of (i) receiving information about commercial microwave links attenuations from received signals levels of commercial microwave links; wherein the commercial microwave links are spread within multiple pixels of a region; (ii) deciding on an existence of fog within at least one pixel of the multiple pixels based on (a) the commercial microwave links attenuations, and (b) a mapping between the commercial microwave links and the multiple pixels; and (iii) generating a two-dimensional fog map of the region based on the existence of fog within at least one pixel of the multiple pixels.

The generating of the two-dimensional fog map of the region may include interpolating information about the at least one pixel.

The generating of the two-dimensional fog map of the region may be further responsive to information obtained by one or more other sensors that differ from microwave radiation sensors.

There may be provided a computer program product that stores instructions that once executed by a computerized system cause the computerized system to execute the steps of (i) measuring received signals levels provided by commercial microwave links; wherein the measuring may be executed by a near-ground sensors network of the commercial microwave links, wherein the commercial microwave links are spread within multiple pixels of a region; (ii) deriving commercial microwave links attenuations from the received signals levels; (iii) deciding on an existence of fog within at least one pixel of the multiple pixels based on (a) the commercial microwave links attenuations, and (b) a mapping between the commercial microwave links and the multiple pixels; and (iv) generating a two-dimensional fog map of the region by interpolating information about the at least one pixel.

The generating of the two-dimensional fog map of the region may be further responsive to information obtained by one or more other sensors that differ from microwave radiation sensors.

There may be provided a computerized system that may include a processor, a memory unit and a near-ground sensors network of commercial microwave links; wherein the near-ground sensors network of the commercial microwave links may be configured to measure received signals levels provided by the commercial microwave links; wherein the commercial microwave links are spread within multiple pixels of a region; wherein the processor may be configured to (i) derive commercial microwave links attenuations from the received signals levels; (ii) decide on an existence of fog within at least one pixel of the multiple pixels based on (a) the commercial microwave links attenuations, and (b) a mapping between the commercial microwave links and the multiple pixels; and (iii) generate a two-dimensional fog map of the region based on the existence of fog within at least one pixel of the multiple pixels.

The processor may be configured to generate the two-dimensional fog map of the region by interpolating information about the at least one pixel.

The processor may be configured to generate the two-dimensional fog map of the region based on information obtained by one or more other sensors that differ from microwave radiation sensors.

There may be provided a computerized system that may include a processor, a communication module, and a memory unit; wherein the communication module may be configured to receive information about commercial microwave links attenuations from received signals levels of commercial microwave links; wherein the commercial microwave links are spread within multiple pixels of a region; wherein the processor may be configured to (i) decide on an existence of fog within at least one pixel of the multiple pixels based on (a) the commercial microwave links attenuations, and (b) a mapping between the commercial microwave links and the multiple pixels; and (ii) generate a two-dimensional fog map of the region based on the existence of fog within at least one pixel of the multiple pixels.

The processor may be configured to generate the two-dimensional fog map of the region by interpolating information about the at least one pixel.

The processor may be configured to generate the two-dimensional fog map of the region based on information obtained by one or more other sensors that differ from microwave radiation sensors.

There may be provided a computerized system that may include a processor, a memory unit and a near-ground sensors network of commercial microwave links; wherein the near-ground sensors network of the commercial microwave links may be configured to measure received signals levels provided by the commercial microwave links; wherein the commercial microwave links are spread within multiple pixels of a region; wherein the processor may be configured to (i) derive commercial microwave links attenuations from the received signals levels; (ii) decide on an existence of fog within at least one pixel of the multiple pixels based on (a) the commercial microwave links attenuations, and (b) a mapping between the commercial microwave links and the multiple pixels; and (iii) generate a two-dimensional fog map of the region by interpolating information about the at least one pixel.

The processor may be configured to generate the two-dimensional fog map of the region based on information obtained by one or more other sensors that differ from microwave radiation sensors.

There may be provided a computerized method for generating a two-dimensional fog map of a region, the method may include (i) deciding on an existence of fog within at least one pixel of the multiple pixels; and (ii) generating the two-dimensional fog map of the region by interpolating information about the at least one pixel, wherein the interpolating may be responsive to topography of the multiple pixels.

There may be provided a computerized method for generating a two-dimensional fog map of a region, the method may include (i) receiving information about an existence of fog within at least one pixel of the multiple pixels; and (ii) generating the two-dimensional fog map of the region by interpolating information about the at least one pixel, wherein the interpolating may be responsive to topography of the multiple pixels.

There may be provided a computer program product that stores instructions that once executed by a computerized system cause the computerized system to execute the steps of (i) deciding on an existence of fog within at least one pixel of the multiple pixels; and (ii) generating the two-dimensional fog map of the region by interpolating information about the at least one pixel, wherein the interpolating may be responsive to topography of the multiple pixels.

There may be provided a computer program product that stores instructions that once executed by a computerized system cause the computerized system to execute the steps of (i) receiving information about an existence of fog within at least one pixel of the multiple pixels; and (ii) generating the two-dimensional fog map of the region by interpolating information about the at least one pixel, wherein the interpolating may be responsive to topography of the multiple pixels.

There may be provided a computerized system that may include a processor, a communication module, and a memory unit; wherein the processor may be configured to (i) decide on an existence of fog within at least one pixel of the multiple pixels; and (ii) generate the two-dimensional fog map of the region by interpolating information about the at least one pixel, wherein the interpolating may be responsive to topography of the multiple pixels.

There may be provided a computerized system that may include a processor, a communication module, and a memory unit; wherein the communication unit may be configured to receive information about an existence of fog within at least one pixel of the multiple pixels; and wherein the processor may be configured to generate the two-dimensional fog map of the region by interpolating information about the at least one pixel, wherein the interpolating may be responsive to topography of the multiple pixels.

There may be provided a computerized method for generating a two-dimensional fog map of a region, the region may be virtually segmented to multiple pixels, the method may include (i) measuring by sensors, receiving or generating microwave attenuation information about attenuation of microwave communication links that are spread within multiple pixels of the region; (ii) calculating a microwave attenuation attribute for each pixel out of a plurality of pixels of the region based on the microwave attenuation information to provide a plurality of microwave attenuation attributes; wherein the plurality of pixels belong to the multiple pixels; and (iii) generating the two-dimensional fog map of the region based, at least in part, on the plurality of microwave attenuation attributes.

The computerized method may include calculating a fog attribute for each pixel of the plurality of pixels based on a microwave attenuation attribute of the pixel.

The computerized method may include calculating a fog attribute of a certain pixel of the multiple pixels based on at least one fog attribute of at least one other pixel of the multiple pixels.

The generating of the two-dimensional fog map of the region may be responsive to additional information that may differ from the plurality of microwave attenuation attributes.

The additional information may include topographic information.

The additional information may include height of the multiple pixels.

The additional information may include humidity measurements.

The additional information may include information from rain sensors.

The additional information may include satellite acquired information.

The additional information may include wind information.

The additional information may include temperature information.

There may be provided a computer program product that stores instructions that once executed by a computer cause the computer to execute the steps of (i) measuring by sensors, receiving or generating microwave attenuation information about attenuation of microwave communication links that are spread within multiple pixels of a region that may be virtually segmented to the multiple pixels, (ii) calculating a microwave attenuation attribute for each pixel out of a plurality of pixels of the region based on the microwave attenuation information to provide a plurality of microwave attenuation attributes; wherein the plurality of pixels belong to the multiple pixels; and (iii) generating a two-dimensional fog map of the region based, at least in part, on the plurality of microwave attenuation attributes.

There may be provided a computerized system that may include a processor, a communication module and a memory unit; wherein the communication module may be configured to receive microwave attenuation information about attenuation of microwave communication links that are spread within multiple pixels of the region; wherein the processor may be configured to calculate a microwave attenuation attribute for each pixel out of a plurality of pixels of the region based on the microwave attenuation information to provide a plurality of microwave attenuation attributes; wherein the plurality of pixels belong to the multiple pixels; and generating a two-dimensional fog map of the region based, at least in part, on the plurality of microwave attenuation attributes.

The computerized system may include sensors for sensing the microwave attenuation.

There may be provided a computerized system that may include a sensors, a group of processors that may include at least one processor, a communication module and a memory unit; wherein the sensors are configured to receive microwave signals transmitted over microwave communication links that are spread within multiple pixels of a region; wherein a first processor of the group of processors may be configured to generate microwave attenuation information about the attenuation of the microwave communication links; wherein a second processor of the group of processors may be configured to (i) calculate a microwave attenuation attribute for each pixel out of a plurality of pixels of the region based on the microwave attenuation information to provide a plurality of microwave attenuation attributes; wherein the plurality of pixels belong to the multiple pixels; and (ii) generate a two-dimensional fog map of the region based, at least in part, on the plurality of microwave attenuation attributes.

The first processor may differ from the second processor.

The first processor may be the second processor.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an example of transmission loss due to fog;

FIG. 2 is an example of an estimation of attenuation resulting from a possible wet antenna;

FIG. 3 is an example of cells clusters;

FIG. 4 is an example of microwave links operating at frequency ranges of between 6 to 40 GHz that are deployed across Israel area;

FIG. 5 is an example of microwave links spread across Israel area at a frequency range of 38 GHz;

FIG. 6 is an example of Map of the microwave links length across Israel;

FIG. 7 is an example of a Parallel sensor network topology;

FIG. 8 is an example of Performance relationships;

FIG. 9 is an example of a Receiver operating characteristic is an example of binary decision between two Gaussian variables;

FIG. 10—The microwave links in pixel n;

FIG. 11 is an example of Grid of pixels and divided links;

FIG. 12 is an example of Fog detection map;

FIG. 13 is an example of an extrapolation kernel having a radius of influence of R=5 (km);

FIG. 14 is an example of three stages for generating fog map using commercial microwave link measurements and topographic data;

FIG. 15 is an example of fog graphic user interface (GUI) tool;

FIG. 16 is an example of IMS station spread across Israel area;

FIG. 17 is an example of a fog map generated using humidity measurements from IMS stations and topographic data;

FIG. 18 is an example of binary image that was created based on RGB values from CAPSAT;

FIG. 19 is an example of a map;

FIG. 20 is an example of a MSG image;

FIG. 21 is an example of a map of fog detection at mount Carmel hills;

FIG. 22 is an example of MSG image zoon in over Haifa area;

FIG. 23 is an example of a map;

FIG. 24 is an example of a MSG image;

FIG. 25 is an example of maps that illustrate a progress of the fog detection process;

FIG. 26 is an example of a map;

FIG. 27 is an example of a MSG image;

FIG. 28 is an example of a map and of an outlier link measurement;

FIG. 29 is an example of a map and ex example of IMS integration;

FIG. 30 is an example of a map;

FIG. 31 is an example of e band microwave measurements versus Meteorological Optical Range (MOR) measurements;

FIG. 32 is an example of e band microwave measurements versus MOR measurements;

FIGS. 33-37 illustrates examples of methods;

FIG. 38 illustrates a system;

FIG. 39 is an example of a satellite image;

FIG. 40 is an example of ROC curves for two events;

FIG. 41 is an example of ROC curves for two events; and

FIG. 42 is an example of a comparison between pixels.

### DETAILED DESCRIPTION OF THE DRAWINGS

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Any reference in the specification to a method should be applied mutatis mutandis to a system capable of executing the method and to a computer program product that is non-transitory and stores instructions to execute the method.

Any reference in the specification to a system should be applied mutatis mutandis to a method that may be executed by the system and to a computer program product that is non-transitory and stores instructions to execute the method.

Any combination of any components of any of the systems illustrated in any of the figures may be provided.

In the claims and specification any reference to the term “consisting” should be applied mutatis mutandis to the term “comprising” and should be applied mutatis mutandis to the phrase “consisting essentially of”.

There is provided a system, a computer program product and a method for generating a two-dimensional (2D) fog map using commercial microwave networks. The actual 2D fog map using real received signal level data from multiple commercial microwave links (MWLs). These links are used as a network of environmental sensors for large spatial coverage. The method developed, combines data from a standard cellular communication network with topographic data about the area where the network is deployed to produce the observations on a national scale.

The system, computer program product and method generate the 2D fog map in a very accurate manner, taking into account additional information that was not previously taken into account may and require measurements from only some of the pixels—thus may rely on a sparser (and thus cheaper and less complex) array of microwave links—and may require less memory space for storage of data.

Microwave Attenuation Due to Atmospheric Phenomena

In the microwave, region losses are generally negligible in the atmospheric in frequencies up to 5 GHz. However, in frequencies above 10 GHz, atmospheric phenomena has significant impact on transmission loss. The total transmission loss for millimeter wave can be described in the next equation:

Attenuation (dB)=92.45+20·log₁₀(f_{GHz})+20·log₁₀(D)+log₁₀(D_{KM})+δ (1)

Where δ (dB) is the total attenuation induced by atmospheric phenomena as: water vapor, mist or fog, absorption due to gases and rainfall.

There are many atmospheric gases/pollutants that have absorption in the millimeters bands (i.e. SO₂, NO₂, O₂, H₂O, and N₂O) however, the absorption is mainly due to water vapor and oxygen compare to the other gases due to the low density of the last. ( ).

In the frequency range of 6 GHz to 40 GHz, typically used for commercial microwave links, which we focus in this work, the attenuation induced to the received signal as a result of interaction with the oxygen molecules is negligible with respect to atmospheric hydrometeors. The work concentrate mainly on fog effecting microwave signal in the above frequency range as will be described in the next paragraph.

Attenuation Due to Clouds and Fog

For clouds or fog consisting entirely of small droplets, generally less than 0.01 cm, the Rayleigh approximation is valid for frequencies below 200 GHz and it is possible to express the attenuation it terms of the total Liquid water content (LWC) per unit volume. Thus the specific attenuation within a cloud or fog can be written as:

γ=ϕ·LWC (2)

Where γ [dB/km] is the attenuation, ϕ is an attenuation coefficient which is temperature and frequency dependent and LWC is the liquid water content.

The liquid water content is the measure of the mass of the water in a cloud in a specified amount of dry air. It's typically measured per volume of air (g/m³).

The attenuation coefficient suggested is based in the Rayleigh approximation (fog drops are generally less than 0.01 cm, small with respect to the centimeter/millimeter microwaves) and is given by—

ϕ=χf (3)

Where χ is a known constant which depends on the dielectric permittivity of water and f is the link's frequency.

After the approximations, the resulting equation, relating between the LWC and the measured attenuation is given by—

γ=χfLᵢₙₜ·LWC (4)

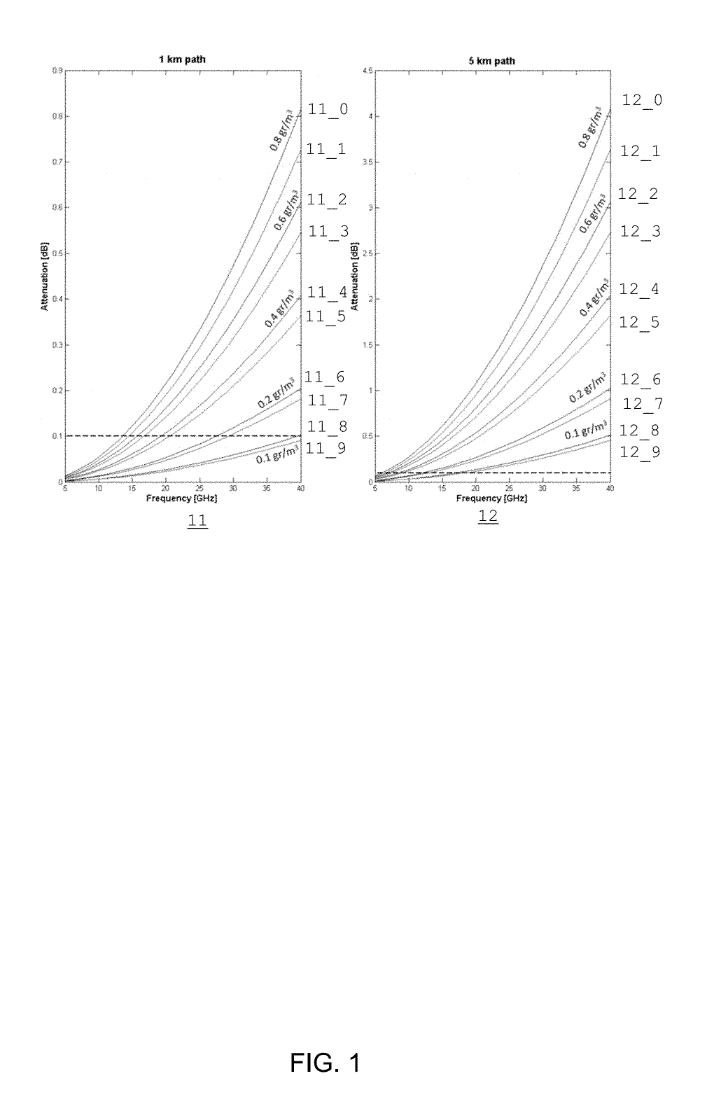

Graph 11 of FIG. 1 presents the theoretical expected attenuation per 1 km created by fog based on, as a function of typical commercial MLs frequencies.

Curves 11_0-11_9 of graph 11 illustrate signal attenuations per 1 km. These curves were created by different levels of fog LWC at temperatures of 15 degrees (11_1, 11_3, 11_5, 11_7, 11_9) and 10° C. (11_0, 11_2, 11_4, 11_6, 11_8), as a function of the ML operating frequency. The dashed line 13 indicates a typical measurements resolution of commercial MLs (0.1 dB).

Graph 12 of FIG. 1 presents the theoretical expected attenuation per 5 km created by fog based on, as a function of typical commercial MLs frequencies.

Curves 12_0-12_9 of graph 12 illustrate signal attenuations per 5 km. These curves were created by different levels of fog concentration at temperatures of 15 degrees (12_1, 12_3, 12_5, 12_7, 12_9) and 10° C. (12_0, 12_2, 12_4, 12_6, 12_8), as a function of the ML operating frequency. The dashed line 13 indicates a typical measurements resolution of commercial MLs (0.1 dB).

Given a certain LWC value, the expected attenuation is greater for higher frequencies, at lower temperatures

The LWCs within fog typically ranges between 0.01 to 0.04 g/m³

The calculation presented in Error! Reference source not found. were made for different LWC values starting at 0.1 g/m³, and at different temperature (10 and 15° C.). The maximum values of LWC were taken from field measurements (including five-minute average values) carried out in the conducting of recent comprehensive field campaigns in different places in the word, using specialized equipment. The expected signal loss was calculated using Eq. (3). The horizontal dashed line indicates the typical measurement resolution of commercial MLs (links with a coarser measurement resolution exist, but will not be the focus of the current section). Notably, that for longer links (graph 12) the effective sensitivity per km increases, and lighter fogs can potentially be detected.

Wet Antenna

Wet antenna induced attenuation due to high level of humidity during fog, a thin layer of water may accumulate on the outside covers of the microwave antenna any may create additional attenuation to the received signal, beyond that caused by the fog in the atmospheric data.

The wet antenna effect is well known as a main source of error when measuring rainfall using a microwave link (ML). However, in our case, the source of possible wettings is different comparing to the case of rainfall since it is resulting from condensation of the atmospheric water vapor due to the high RH. We suggest that this effect is likely to be considerable also in the case of fog monitoring using MLs. We note that the wetness on one radio unit might be different from that on a different unit due to differing atmospheric conditions, antenna elevations, etc. As a result, this phenomenon might cause different attenuation levels from link to link and add to the uncertainty in the measurements. On the other hand, a positive contribution of this wet antenna component is that it may be utilized as an additional fog detection factor. In order to reduce the measurement errors resulting from these different factors, we utilized the availability of multiple measurement sources and the diversity of such sources based on the availability inherent in the nature of typical communication systems. Particularly, we were able to derive an estimate for the wet antenna attenuation and reduced the sources of random error.

The estimation of attenuation resulting from a possible wet antenna, A_{w}, is carried out by evaluating the y intercept of the line (which represent a theoretical distance of 0 between antennas)—a vertical displacement of a line that approximates the relationship between attenuation and distance.

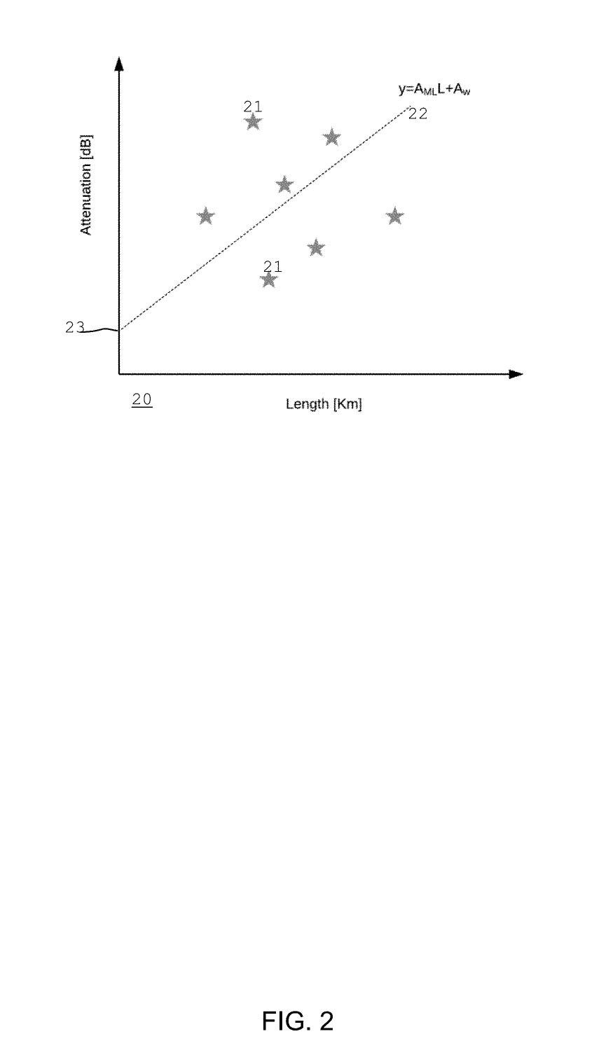

The stars 21 in graph 20 of FIG. 2 indicate the ML plotted on XY axis where the X axis state for the microwave link length and the Y axis for the attenuation on dB. The line 22 of best fit is calculated by least square regression line method. The intersection point 23 between line 22 and the Y axis represents the attenuation resulting from the wet antenna.

Spatial Distribution of Microwave Links

Cellular radio makes better use of the limited frequency spectrum available for mobile radio by re-using the same frequencies many times over. Frequency re-use is achieved by dividing a large geographical area into a number of small, nominally hexagonal areas, knows as cells, over the whole country. The transmitted power level of each base station is limited to restrict the coverage area of that base station. Frequencies are assigned in such a way that the same frequency can be used for different transmission only a few cells away.

The cells are arranged in clusters and the allocated bandwidth is divided between the cells in each cluster. Three cells cluster 31, four cells cluster 32, and seven cells clusters 33 are shown in Error! Reference source not found.

Regular patterns of clusters then give total coverage of the geographical area. Map 34 shows how coverage is achieved using a large number of seven cells clusters.

Cellular radio uses multitudinous access points sited according to local traffic demands. The physical size of a cell is limited by radio wave propagation characteristics. At high frequencies (UHF/VHF) the propagation is “line-of-sight’ and the coverage area are influenced by buildings and the local terrain. In town center the size of a cell may be as small as 1 KM in diameter, also known as a microcell.

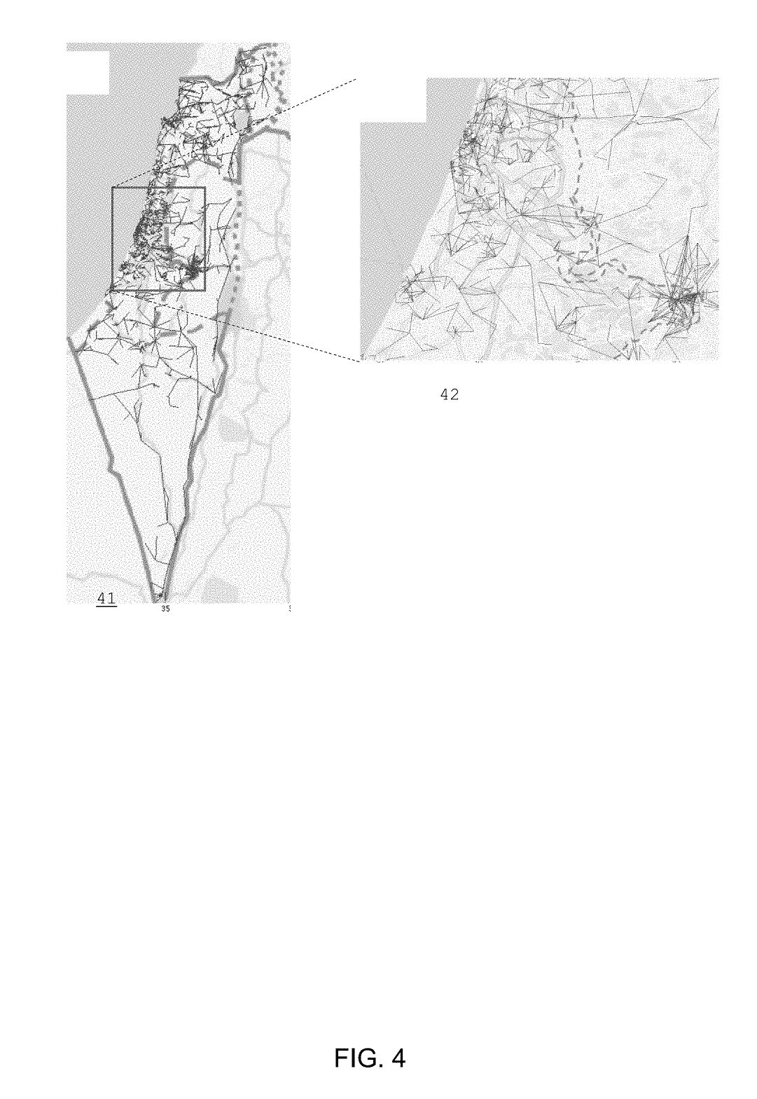

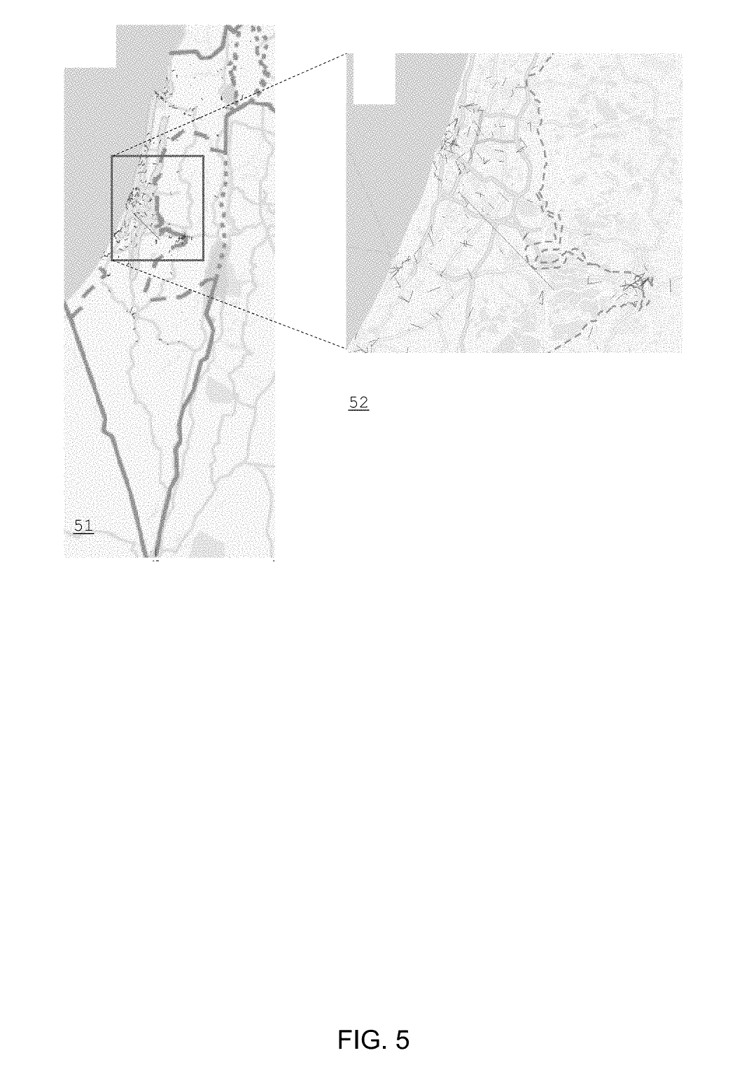

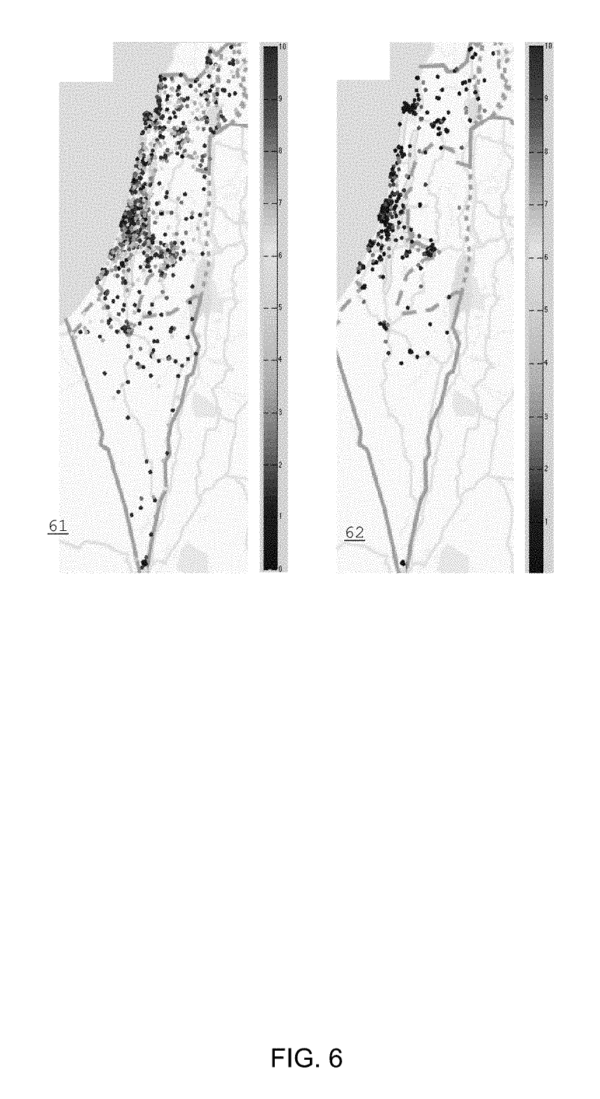

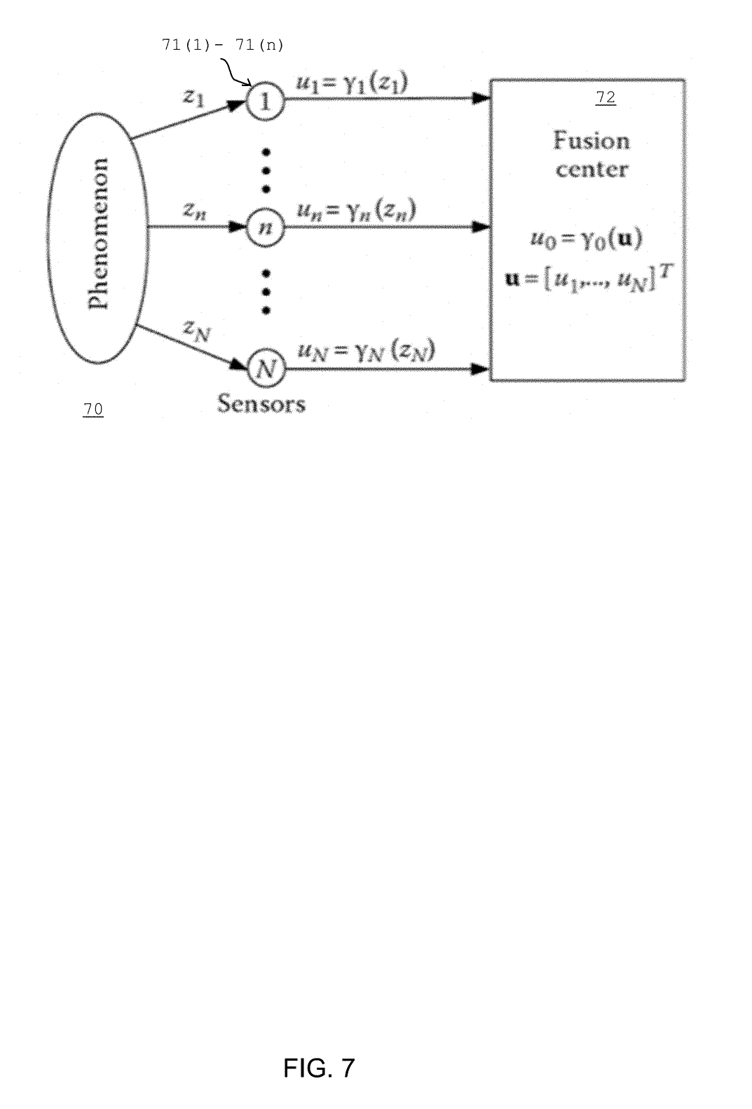

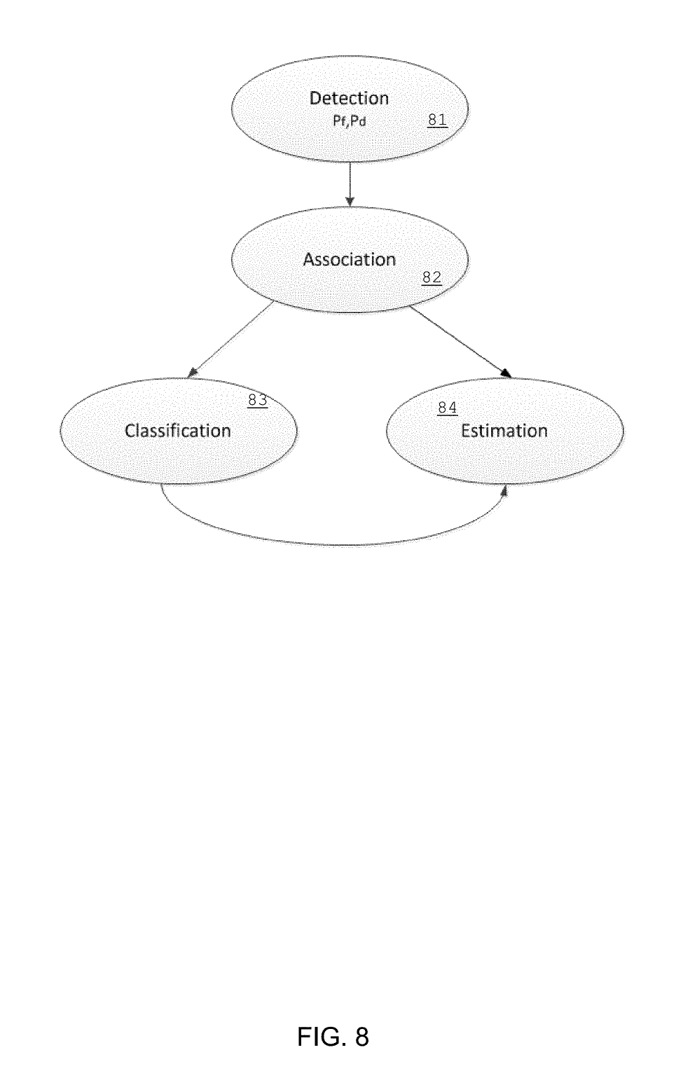

Map 41 of FIG. 4 shows Cellcom (Israel cellular provide) widely spread microwave links a cross Israel area, the links frequency range is 18-38 GHz. It can be seen that in the zoomed area 42, central area of Israel there is high concentration of links due to high traffic demand.

Error! Reference source not found. shows map 51 and zoomed map 52—that illustrate the base stations that work at frequency range of 38 GHz, this frequency range is most effective for fog detection as discussed in previous chapter.

In urban areas where the density of users is higher and propagation more challenging, usually the links length is short ˜1 KM compare to non-urban areas where the links length can get to several kilometers and even a few tens of kilometers.

Error! Reference source not found. shows the separation of microwave links by link length in Israel area. Map 61 present the links over all frequency range and map 62 presents the links for the frequency range of 38 GHz. The color-bar illustrate the link length in kilometers, blue points indicate links which their length is less than 2 KM and the red points for longer links for ten of kilometer. One can see that for high frequency as 38 GHz, the length of the links is less than 1 KM mainly due to propagation and the sensitivity to environment phenomena such as: rain, fog and humidity.

Distributed Detection Vs. Centralized Detection

The problem of signal detection can be formulated as a binary hypothesis testing problem where the hypothesis H₀ and H₁ represent the absence and presence of a signal, respectively. In our case the hypothesis represent the absence and presence of fog based on RSL measurements from each sensor (cell).

Assume that N sensors are deployed in the region of interest (ROI) to collect observation Zₙ, for n=1, . . . N. In traditional centralized detection, each sensor node transmits a sequence of L observation to a fusion center for deciding the true state of nature. However, centralized processing based on raw observation from multiple sensors is neither efficient nor necessary. It may consume excessive energy and bandwidth in communication and may impose a heavy burden at the central processor therefore some applications require local compression/processing of the raw observation before transmission.

In a distributed decision-making system, various forms of sensor compression, uₙ=γₙ(Zₙ), can be employed. For example, the local sensor output can be a hard decision so that γₙ∈{0,1} or a soft decision, where γ(Zₙ) can take multiple values as RSL measurements.

Based on the compressed data u=[u₁, . . . , uₙ], the fusion center makes a global decision u₀=γ₀(u) that either favors H₁(u₀=1) or H₀(u₀=0).

FIG. 1 illustrates a Parallel sensor network topology 70.

A phenomenon is sensed by n sensors 71(1)-71(n) that feed their detection signals to fusion center 72.

From the signal processing perspective, two different problems need to be considered for the distributed detection system:

The design of local sensor signal processing rules, [γ₁, . . . , γₙ]

The design of γ₀, the decision rule at the fusion rule, also known as the fusion rule

In most general setting, the design of the set of decision rules Γ=[γ₁, . . . , γₙ, γ₀], is a NP (Neyman-Pearson)-complete problem (TBD). However, it becomes tractable by assuming conditionally independent sensor observation, that is,

$$f ( {z}_{1} , … {z}_{n} \vert {H}_{i} ) = {\prod }_{n = 1}^{N} {f}_{n} ( {z}_{n} \vert {H}_{i} ) , ∀ i = 0 , 1 \qquad ( 5 )$$

Where fₙ(⋅|Hᵢ) represent the probability density function (PDF) of sensor n under hepothesis Hᵢ.

A common framework for solving decision problems is to maximize the probability of detection for predetermined constraint on the probability of false alarm, also is known as NP (Neyman-Pearson) framework of hypothesis testing. An alternative approach for decision rules is the Bayesian approach which considers that each hypothesis is a random entity.

In the following sections, the decision rules at local sensors and fusion center are designed according to Bayesian and NP formulation for the parallel configuration

Bayesian Formulation

The vector of sensor decision denoted as u=[u₁, . . . , uₙ] so that the conditional densities under the two hypotheses are p(u|H₀) and p(u|H₁) respectively. The a priori probabilities of the two hypotheses denoted by P(H₀) and P(H₁) are assumed to be known. In the binary hypothesis testing problem, four possible action can occur. Let C_{i,j}, i∈{0,1}, j∈{0,1} represent the cost of declaring Hᵢ true when Hⱼ is present. The Bayes risk function is given by:

$$= {\sum }_{i = 0}^{1} {\sum }_{j = 0}^{1} {C}_{i , j} P ( {H}_{j} ) P ( Decide {H}_{i} \vert {H}_{j} is present ) = {\sum }_{i = 0}^{1} {\sum }_{j = 0}^{1} {C}_{i , j} P ( {H}_{j} ) {\int }_{{u}_{i}} p ( u \vert {H}_{j} ) du \qquad ( 6 )$$

Where uᵢ is the decision region corresponding to hypothesis Hᵢ which is declared true for any observation falling in the region uᵢ. Assume u be the entire observation space so that u=u₀∪u₁ and u₀∩u₁=ϕ.

If C_{0,0}=C_{1,1}=0 and C_{0,1}=C_{1,0}=1, we have the minimum probability of error criterion. , [symbol] =Pₑ=P(u₀=1|H₀)P₀+P(u₀=0|H₁)P₁. The probability of error is given by:

Pₑ=P(H₀)P_{F}+P(H₁)(1−P_{D}) (7)

Where,

P_{F}=P(u₀=1|H₀) denotes the probability of false alarm
P_{D}=P(u₀=1|H₁) denotes the probability of detection

Given the vector of local sensor decisions, u, the probability of error is expresses as:

Pₑ=P(H₁)+P(u₀=1|u)[P(H₀)P(H₀)P(u|H₀)−P(H₁)P(u|H₁)] (8)
The earlier property leads to the following likelihood ratio test (LRT) at the fusion center (TBD):

$$\frac{P ( u \vert {H}_{1} )}{P ( u \vert {H}_{0} )} = {\prod }_{k = 1}^{K} \frac{p ( {u}_{k} \vert {H}_{1} )}{p ( {u}_{k} \vert {H}_{0} )} \begin{matrix}{>}^{{u}_{0} = 1} \\ {<}_{{u}_{0} = 0}\end{matrix} \frac{P ( {H}_{0} )}{P ( {H}_{1} )} \qquad ( 9 )$$

Conditional independence assumption and establishing the optimality of LRT at local sensors does not completely solve the problem.

Neyman-Pearson Formulation

The NP can be formulated more precisely as follows: find optimal decision rule Γ that maximize the probability of detection P_{D}=P(u₀=1|H₁) given the false alarm constraint P_{F}=P(u₀=1|H₀)≤α. For conditionally independent sensor observation the local sensor rules and fusion role are likelihood ration tests.

$$\frac{{f}_{n} ( {z}_{n} \vert {H}_{1} )}{{f}_{n} ( {z}_{n} \vert {H}_{0} )} \{ \begin{matrix}> {t}_{n} , & then {u}_{n} = 1 \\ = {t}_{n} , & then {u}_{n} = 1 with probability {ϵ}_{n} \\ < {t}_{n} , & then {u}_{n} = 0\end{matrix} \qquad ( 10 )$$

For n=1, . . . N,

$${\prod }_{n = 1}^{N} \frac{P ( {u}_{n} \vert {H}_{1} )}{P ( {u}_{n} \vert {H}_{0} )} \{ \begin{matrix}> {λ}_{0} , & decide {H}_{1} or set {u}_{0} = 1 \\ = {λ}_{0} , & randomly decide {H}_{1} with probability ϵ \\ < {λ}_{0} , & then {u}_{n} = 0\end{matrix} \qquad ( 101 )$$

The thresholds λ₀ in (11) as well as the local threshold tₙ in (10) need to be determined so as to maximize P_{D} for a given P_{F}=α.

Note that the framework described above refers to the case where the local detectors are allowed to make only hard decisions, that is in Equation 10, uₙ can take only two values, 0 or 1.

Design of Fusion Rules

Given the local detectors, the problem is to determine the fusion rule to combine local decisions optimally. Let's first consider the case where local detectors make only hard decisions i.e. uₙ can take only two values 0 or 1 corresponding to the two hypotheses H₀ and H₁. Then, the fusion rule is essentially a logical function with K binary inputs and one binary output.

Let denote P(uₖ=1|H₀) the probabilities of false alarm and P(uₖ=1|H₁) as detection of sensor k. According to (9) and (11), the optimum fusion rule us given by the LRT:

$${\prod }_{k = 1}^{K} \frac{p ( {u}_{k} \vert {H}_{1} )}{p ( {u}_{k} \vert {H}_{0} )} \begin{matrix}{>}^{{u}_{0} = 1} \\ {<}_{{u}_{0} = 0}\end{matrix} λ \qquad ( 12 )$$

This rule can also be expressed as:

$${\sum }_{k = 1}^{K} [ log \frac{P ( {u}_{k} = 1 \vert {H}_{1} ) ( 1 - P ( {u}_{k} = 1 \vert {H}_{0} ) )}{P ( {u}_{k} = 1 \vert {H}_{0} ) ( 1 - P ( {u}_{k} = 1 \vert {H}_{1} ) )} ] {u}_{k} \begin{matrix}{>}^{{u}_{0} = 1} \\ {<}_{{u}_{0} = 0}\end{matrix} log λ + {\sum }_{k = 1}^{K} log \frac{1 - P ( {u}_{k} = 1 \vert {H}_{0} )}{1 - P ( {u}_{k} = 1 \vert {H}_{1} )} \qquad ( 13 )$$

This rule also called as the Chair-Varshney fusion rule.

Then, the optimum for the fusion rule can be implemented by forming a weighted sum of the incoming local decisions and comparing it with a threshold. The weights and the threshold are determined by the local probabilities of detection and false alarm.

If the local decisions have the same statistics, the Chair-Varshney reduces to a T-out-of-K form or a counting rule, which reduce the computational complexity considerably.

Counting Rule

Without the knowledge of local sensors, detection performance and their positions, an approach at the fusion center is to treat every sensor equally. An intuitive solution is to use the total number of “1”s as a statistic since the information about which sensor report a “1” is of little use to the fusion center. A counting-based fusion rule may be proposed, which uses the total number of detections transmitted from local sensors as the statistic:

$${\sum }_{k = 1}^{K} {u}_{k} \begin{matrix}{>}^{{u}_{0} = 1} \\ {<}_{{u}_{0} = 0}\end{matrix} T \qquad ( 14 )$$

Where T is the threshold at the fusion center, which can be decided by prespecified probability of false alarm. The above fusion rule called the counting rule. It is an attractive solution, since it is quite simple to implement, and achieves very good detection performance in a wireless sensor networks with randomly and densely deployed low cost sensor nodes as you see in the next chapter.

For the counting rule, as in (14), under hypothesis H₀, the total number of detection Σₖ₌₁^{K} uₖ follows a binomial distribution. For a given threshold T, the false alarm rate can be calculated as follows:

$$\begin{matrix}{P}_{F} = {\sum }_{k = T}^{K} ( \frac{K}{k} ) {{P}_{f}^{k} ( 1 - {P}_{f} )}^{N - k} & ( 15 ) \\ {P}_{D} = {\sum }_{k = T}^{K} ( \frac{K}{k} ) {{P}_{d}^{k} ( 1 - {P}_{d} )}^{N - k} & ( 16 )\end{matrix}$$

While, P_{f,k}=P(uₖ=1|H₀),P_{d,k}=P(uₖ=1|H₁) and P_{f,1}= . . . P_{f,K}=P_{f}

Performance Considerations

It is important to recognize that the process of detection, tracking and classification are coupled, and overall performance includes critical interaction between these processes.

Error! Reference source not found. illustrate the basic relationship, in which detection performance 81 directly influence the performance of the association process 82. Poor detection in one sensor, degrades the ability of a correlator to distinguish between targets. The association is followed by classification 83 and estimation 84.

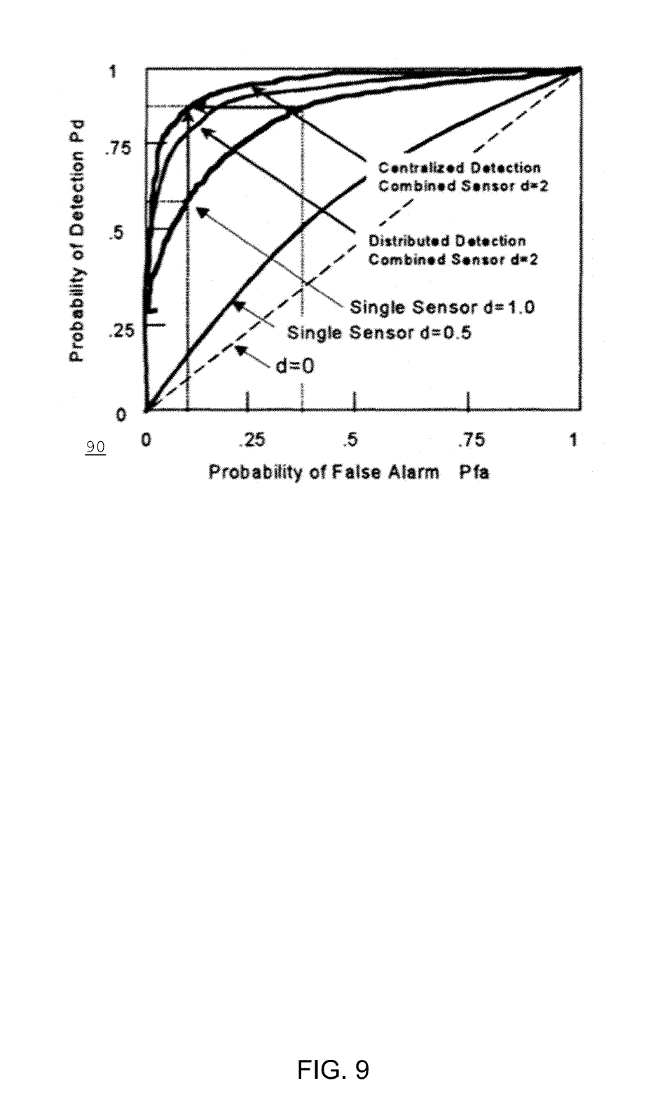

Multi-sensing provides improved detection performance by combining data or decisions from more than one sensors, observing a common object. By signal integration the combined object signal is increased over that of uncorrected noise, raising the composite multi-sensor SNR ratio, the detection probability (Pd) and the false alarm probability are increasing and reducing respectively for a given decision threshold. The relative detection performance improvements of distributed and centralized combination of sensors are illustrated in graph 90 of FIG. 9 on the standard receiver operating characteristic (ROC) plots of Pd and Pf.

The classification of the sensors may be done according to the decision if fog was presence or not.

Spatial Fog Mapping

Detection

Multiple detection method s may be applied.

For example—when applying a centralized decision—the readings of sensors in a pixel are taken into account when determining whether there is fog in the pixel.

For example—a value of a certain function (for example average, weighted average, mean, and the like) applied on the readings of the sensors may determine whether there is fog—for example—whether the average value exceeds a certain threshold—there is fog in the pixel.

Yet for another example—when applying a distributed decision—each sensors may decide whether it senses fog—and the determination of whether there is a fog in a pixel takes into account the decisions of the sensors. For example—at least a certain number (or a certain percent) of the detectors determines that there is fog in the pixel—in order to determine that there is fog. For example—a majority decision may be applied.

Yet for another example—sensors in the pixel may be grouped to multiple groups—and each group generated a group decision about the existence of fog in the pixel (based on readings of the sensors of the group)—and the determinations of the multiple groups are taken into account when eventually deciding that there is a fog in the pixel.

The microwave links can be treated as wide spread sensors while each link compose of transmit base station (BS) and receive BS. The sensors data represented as the received signal level (RSL), we assume that along the link the measured RSL is constant. Therefore, we can divide the links to several points in order to increase the spatial resolution. We shall divide the space into uniform grid, let's note each rectangle that generated by the crossing of the grid as Pₙ, each pixel (Pₙ) composes of several sensors from different links. The decision rule can formalize as following: assume we have N sensors inside the pixels, we denote each sensor as Rₖ, k=1 . . . N, Rₖ represent the RSL measurement at sensor k. Let's first consider the case of distributed detection where local detectors make only hard decisions i.e. uₖ can take only two values 0 or 1, we compare each sensor RSL to predefined threshold T.

$${R}_{k} \begin{matrix}{>}^{{u}_{k} = 1} \\ {<}_{{u}_{k} = 0}\end{matrix} T \qquad ( 17 )$$

The pixel's decisions are independent, and each pixel can be described as fusion center, the decision if fog was presence in pixel k made by counting rule:

$${\sum }_{k = 1}^{K} {u}_{k} \begin{matrix}{>}^{{P}_{n} = 1} \\ {<}_{{P}_{n} = 0}\end{matrix} \frac{K}{2} \qquad ( 18 )$$

For the centralized detection, the Rₖ, each sensor node transmits the RSL observation to a fusion center for deciding if the fog is presence in the current pixel. For each pixel, we calculate the wet antenna attenuation based on measurements from all sensors. The next stage is to averaging the normalized RSL from all sensors and compare it to predefined threshold.

$${\sum }_{k = 1}^{K} ( {R}_{k} - W \cdot A ) \begin{matrix}{>}^{{P}_{n} = 1} \\ {<}_{{P}_{n} = 0}\end{matrix} T \qquad ( 19 )$$

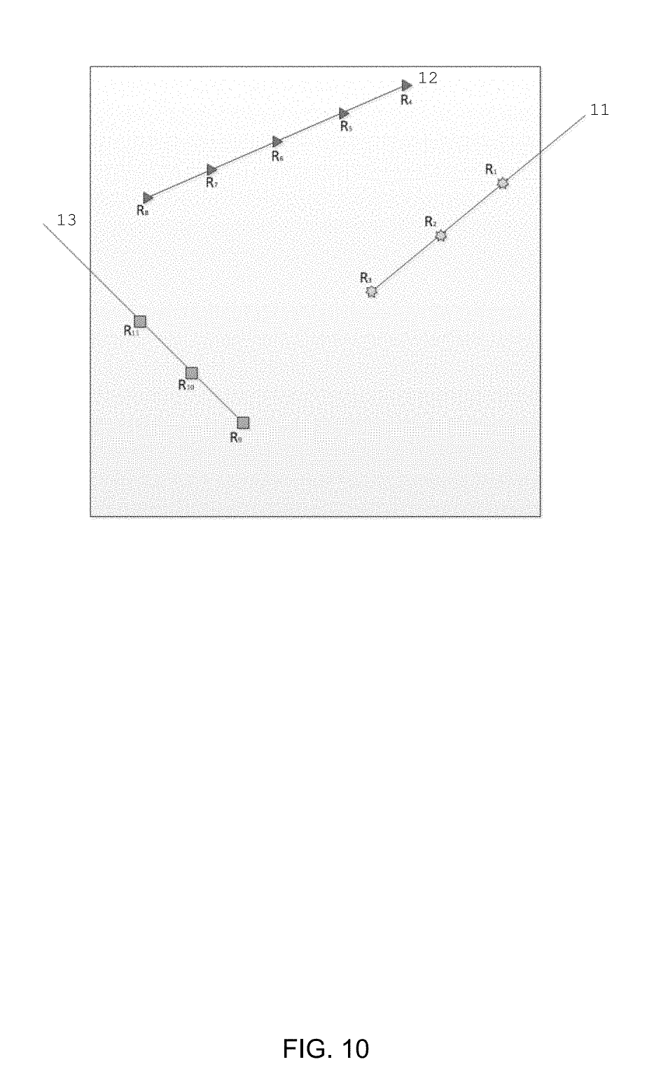

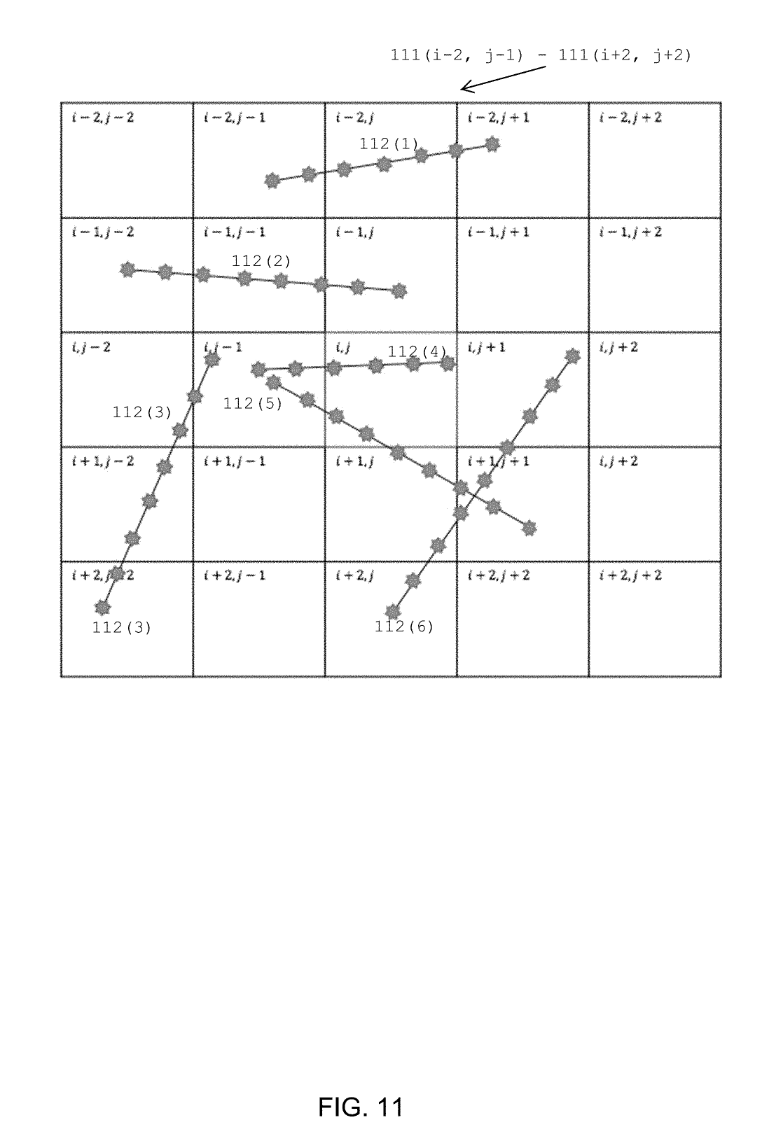

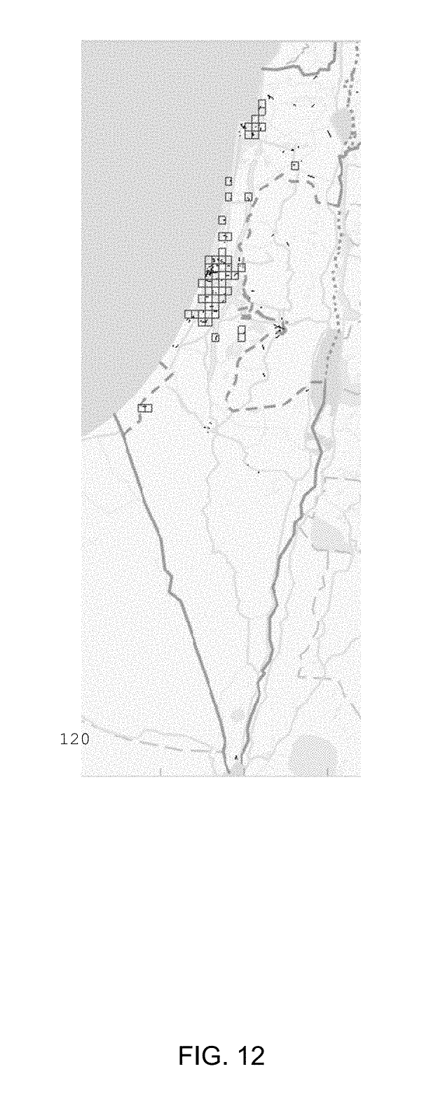

Error! Reference source not found. illustrate the microwave links in pixel n, each link divide to several sensors/points. FIG. 10 illustrates a first link 11 that includes sensors R₁-R₃, a second link 12 that includes sensors R₄-R₈, and a third link 13 that includes sensors R₉-R₁₁.

Under the assumption that the attenuation is equal along the link, Rₖ present the RSL at sensor k. The fusion center treats the sensors independently and the decision made according the options presented above.

| | Classified as Fog | Classified as non-Fog |
|---|---|---|
| Actual Fog | True positive (TP) | False negative (FN) |
| Actual non-Fog | False positive (FP) | True negative (TN) |

For the fog event in 2005 the next table summarize the classification performance over several thresholds for distributed detection:

| | | Distributed | | | |
|---|---|---|---|---|---|
| | | detection | | Centralized detection | |
| | | | Classified | | Classified |
| Thresh- | | Classified | as | Classified | as |
| old | | as Fog | non-Fog | as Fog | non-Fog |
| 0.1 | Actual Fog | 504/868 | 0/308 | | |
| | Actual non-Fog | 364/868 | 308/308 | | |
| 0.15 | Actual Fog | 504/848 | 0/328 | | |
| | Actual non-Fog | 344/848 | 328/328 | | |
| 0.2 | Actual Fog | 504/832 | 0/344 | | |
| | Actual non-Fog | 328/832 | | | |
| 0.25 | Actual Fog | 504/784 | | | |
| | Actual non-Fog | 280/784 | | | |
| 0.3 | Actual Fog | 504/784 | | | |
| | Actual non-Fog | 280/784 | | | |
| 0.35 | Actual Fog | 504/784 | | | |
| | Actual non-Fog | 280/784 | | | |
| 0.4 | Actual Fog | 504/784 | | | |
| | Actual non-Fog | 280/784 | | | |
| 0.45 | Actual Fog | 504/768 | | | |
| | Actual non-Fog | 264/768 | | | |
| 0.5 | Actual Fog | 504/768 | | | |
| | Actual non-Fog | 264/768 | | | |
| 1 | Actual Fog | 408/656 | | | |
| | Actual non-Fog | 248/656 | | | |
| 1.5 | Actual Fog | 352/576 | | | |
| | Actual non-Fog | 224/576 | | | |
| 2 | Actual Fog | 203/368 | | | |
| | Actual non-Fog | 165/368 | | | |
| 2.5 | Actual Fog | 100/240 | | | |
| | Actual non-Fog | 140/240 | | | |
| 3 | Actual Fog | 49/128 | | | |
| | Actual non-Fog | 79/128 | | | |
| 4 | Actual Fog | 23/48 | | | |
| | Actual non-Fog | 25/48 | | | |
| 5 | Actual Fog | 0/16 | | | |
| | Actual non-Fog | 16/16 | | | |

Method

The method developed carries out fog coverage map (areas where fog existed/did not exist) in space, based on the local topographic data, and the measurements of the commercial MWLs deployed in the observed area. Ruling out rainfall, which induces attenuation on the links, is done using side information from rain gauges deployed in the observed area. The method divides the space into uniform grid with user configurable dimensions, and decides whether fog existed in each particular pixel or not. The assumption is that if attenuation is measured in a certain pixel (after ruling out rain using side information) it is induced by fog. It is also assumed that if fog exists in a certain pixel, it is homogeneous throughout the pixel.

Evaluating the Fog Induced Attenuation.

Each microwave link of length L (kms) is divided into N segments according to a user setting:

$$N = ⌊ \frac{L}{k} ⌋ \qquad ( 20 )$$

Where k indicates the length of each segment (kms).

Error! Reference source not found. illustrate the divided links and the number of links in each pixels. The pixels are arranges in a 5×5 grid—including pixels Pixel(i−2, j−2) till pixel (i+1, j+2)—denoted 111(i−2, j−2)-111(i+2, j+2). There are six links 112(1)-112(6) in the grid.

In pixel 111(i,j) there are two links (112(4) and 112(5)) and six points. The attenuation in the pixels is calculated according to the points inside the pixel, assuming the points from the same link has the same attenuation. We treat to each pixel independently, one can assume dependence between the pixels in order to get more accurate detection, it requires additional examination and further research.

The method calculates an attenuation value for each segment, signified as γ_{N} (dB).

In order to calculate this value, the method selects the median RSL measurement (defined as the reference level), for each link, from a user defined measurement history.

During times when the RSL decreases below the link's median RSL, the attenuation is calculated by subtracting the RSL value of that given time from the reference level.

The method calculates the average attenuation for each pixel \hat{χ} (dB) as follows:

$$\hat{χ} = \frac{{\sum }_{i = 1}^{M} {γ}_{Ni}}{M} \qquad ( 21 )$$

While M indicates the number of segments located in the pixel (Segments can be from different links).

Relative humidity (RH) during fog is high, and thus, a thin layer of water may condense on the microwave antennas, inducing additional attenuation, that is not due to the fog in the link path. Wet antenna attenuation, ŵ (dB), is calculated for each pixel according to the procedure detailed above.

The RSL Over the MWLs is Quantized.

Magnitude resolution for these systems is typically between 0.1 and 1 dB. Thus, when the following condition is met:

\hat{χ}−ŵ>3Q (22)

The method positively detects fog for that given pixel, where Q (dB) indicates the systems quantizing error.

Error! Reference source not found. presented the fog detection map 120 for fog event took place in the early morning hours of 10 Dec. 2005. The red rectangle represent pixels which fog was induced attenuation in the ML interior to pixels area, the pixel area is 4×4 km².

It is assumed that the pixels are independently, the classification of pixel was not impacted by neighbor pixels. One can assume there is dependency between pixels in several aspects (frequency, location, etc.).

Yet it is noted that topographic data (such as difference in heights), weather condition (Relative humidity, wind—speed of wind, sun radiation) can be used to evaluate the effect on one pixel on another.

Topographic Data Inclusion

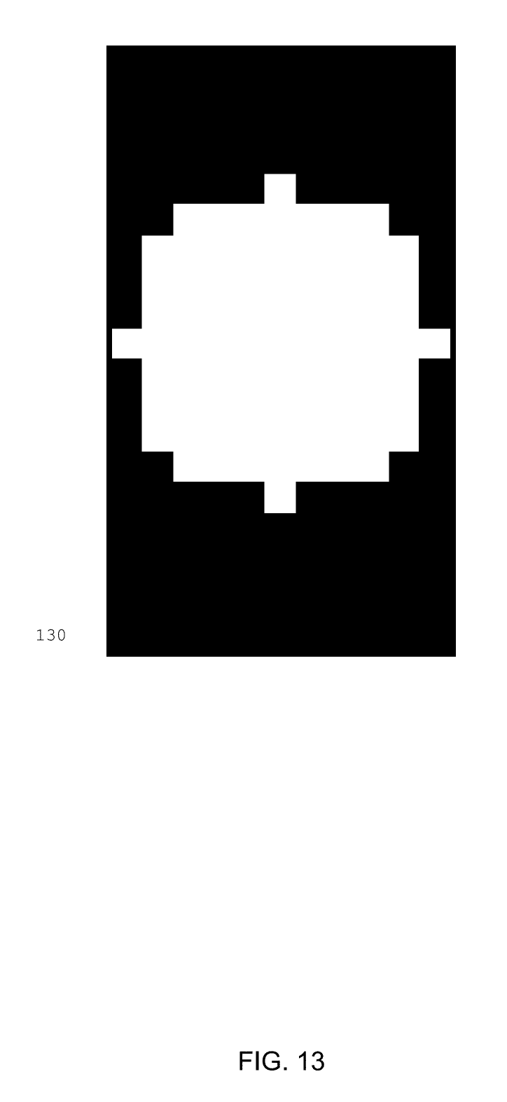

Topographic data is used as supplementary information to the link measurements. The principle by which this data is combined in can be compared to a case where water fills a volume from a certain, known, height and downwards, as long as the topography around provides a vessel for the liquid. Similarly, in our case, the link's receiver/transmitter elevations above sea level are known. A radius of influence—R (km) is defined around each pixel where fog was detected by the link measurements. All the surrounding pixels whose topographic height satisfies the requirement of being lesser or equal to the link elevation are then signified as pixels where fog is present. FIG. 13 illustrates an extrapolation kernel 130.

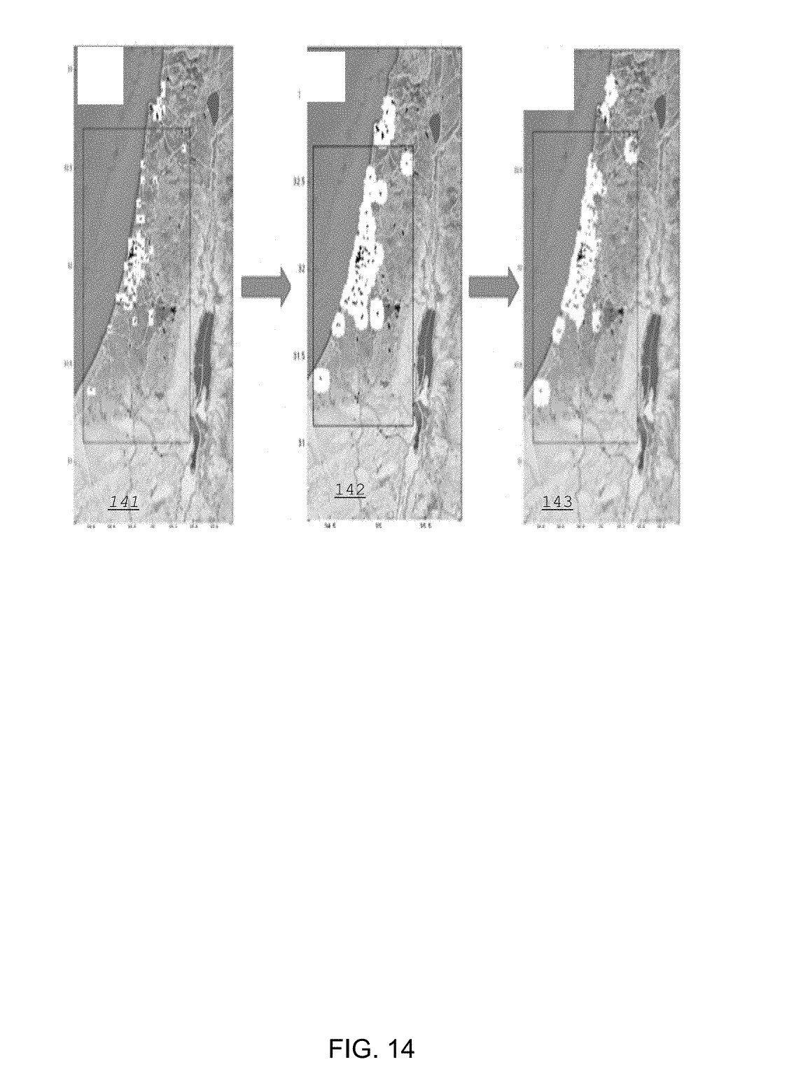

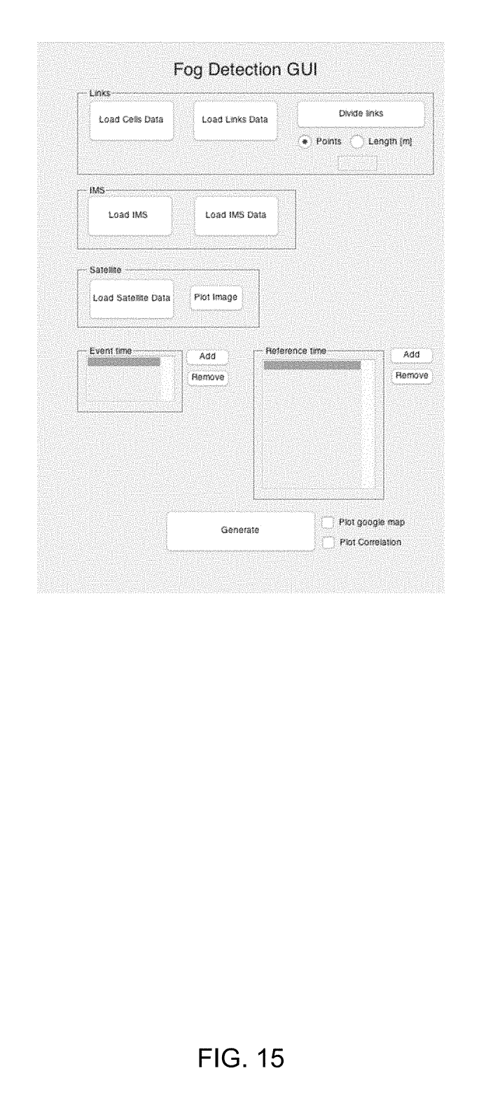

The first stage for generating the extrapolate fog map is to up-sampling the detection map in order to earn more spatial resolution. Map 141 of FIG. 14 represent the up-sampled detection map (the up-sampling factor is four for rows and columns). The second stage is to generate extrapolate binary image using the kernel illustrated in Error! Reference source not found., we use here radius of influence R=5 (km). Map 142 represent the extrapolate image of the detection map (the up-sampled version). The third and the last stage is selecting the pixels whose topographic height meet the requirement of being lesser or equal to the link evaluation, map 143 illustrate the results of the topographic data inclusion described in this chapter.

### Yet Another Example

It has been found that commercial microwave networks may detect fog locally and also may be used for creating actual 2D fog maps.

There is provided a method for fog mapping, using real RSL measurements from hundreds of Commercial Microwave Links (CMLs) over area of hundreds of square kilometers. These links are utilized as a network of virtual sensors for fog detection. The method combines data from a standard cellular communication network with high-resolution topographic data and humidity gauge measurements (if available), where the network is deployed in order to generate 2-D fog observations on a national scale.

Assuming that prior knowledge is available that no rain exists, the attenuation of the microwave signal in a CML is mainly caused by other-than rain phenomena, e.g., fog.

Our proposed method set the boundaries of the fog on a map, based on the available near ground CML measurements.

The mapping process is divided into three layers as follows: in layer I the CML measurements are converted to numerous virtual local fog sensors. In layer II the set of local measurements are used to create a 2D fog map, and in layer III the possibility to improve the map using available additional sensors is demonstrated. The final product maps the areas where fog existed or not over a geographic map.

Layer I: From microwave link network to fog detection sensor (detectors) array

This part of the method divides the space into a uniform grid with user configurable dimensions, and detects whether fog existed in each particular pixel or not.

In order to calculate the attenuation across the CML, the median RSL measurement (defined as the reference level) is selected for each link, from a user defined measurement history. During times when the RSL decreases below the link's median RSL, the attenuation is calculated by subtracting the RSL value of that given time from the reference level. Each CML of length L (km) is artificially divided into N equal segments according to the user's choice, where each segment is a virtual fog sensor. The method calculates a fog induced attenuation value, signified as γ_{N}, for each link segment.

According to detection theory, the problem of signal detection can be formulated as a binary hypothesis testing problem. In our case, the hypothesis represents the absence and presence of fog at each pixel based on the attenuation measurements from the sensors (link segments) crossing this pixel. The detection structures either make an independent detection decision at the sensors and then combine these decisions at the central node (“distributed detection”) or perform the detection decision on the basis of all the sensor data at a common node (“centralized detection”). The method developed, as described next, carries out detection according to any of these theories, based on the user's choice.

Centralized detection. In this approach the method calculates the average attenuation for each pixel, \hat{χ}, as follows:

$$\hat{χ} = \frac{{\sum }_{i = 1}^{M} ( {γ}_{Ni} )}{M}$$

The average is a special case of a weighted sum, used when appropriate weights can be assigned.

While M indicates the number of segments located in the pixel (segments can be from different links).

Relative humidity (RH) during fog is high (95-100%) and thus, a thin layer of water may condense on the microwave antennas, inducing additional attenuation, that is not due to the fog across the link path. The wet antenna attenuation is calculated and offset from each CML, prior to the averaging stage described above, according to the procedure detailed in David et al., (2013).

The principle for this calculation is based on generating a linear fit between attenuation as a function of link length, for all links that are located within a pixel where the fog observation is being carried out (in cases where only part of the link is located inside the pixel, the calculation is performed as if the entire link was within the same pixel). The y-intercept of the linear fit indicates the attenuation value at an imaginary infinitesimal distance between the link antennas, i.e. a value that indicates wet antenna attenuation. The RSL over the CMLs is quantized. Magnitude resolution for these systems is typically between 0.1 and 1 (dB).

Thus, when the following condition is met: \hat{χ}>Q₁

The method positively detects fog for that given pixel, where Q₁ (dB) indicates a threshold experimentally determined in relation with the microwave system's quantization error.

Distributed detection. When the user selects this method for detection, the method calculates, for each segment, whether the following condition occurs: γ_{Ni}>Q₂

Naturally, the chosen threshold Q₂ (dB) is higher than the quantization value in the corresponding link.

In the next stage, the number of times the condition occurred or did not occur is counted, and a decision regarding the existence of fog in the given pixel is made based on the larger count value.

Layer II: Topographic Data Inclusion

Topographic data is used as supplementary information to the link measurements. The principle by which this data is combined can be compared to a case where water fills a volume only down from a certain known level as long as the topography around provides a vessel for the liquid. Similarly, in our case, the link's receiver/transmitter elevations above sea level are known. A radius of influence—R (km) is defined around each pixel where fog was detected by the link measurements (Layer I). All the surrounding pixels whose topographic height satisfies the requirement of being lesser or equal to the link elevation are then signified as pixels where fog is present.

Layer III: Humidity Gauge Data Inclusion

With the prior knowledge that a fog event took place at a certain date, the method generates a fog map using a similar process to the one described in layers I and II, while in this time the process is based on humidity gauge observations along with the topography as described earlier. It is defined that when the RH measured by the humidity gauges is greater or equal to 93%—fog is considered to exist at that point, and in a designated (user defined) radius around it. The propagation pattern of the fog in space is determined by the areal topography as described in layer II.

Note that fog typically occurs in cases where RH>95% (e.g. Quan et al., 2011), but since the humidity gauges in use have a measurement error of 2% for values above 90%, the boundary value of 93% was selected.

In the last stage, the method combines the products of the three layers, and generates a two-dimensional fog map. The determination of whether fog existed or not in areas where there is overlap between the link-based map from layers I and II, and the fog map generated from the humidity gauge measurements (layer III) is carried out based on the principle that the humidity gauge is the dominant factor in making the decision. That is, in cases where there was a contradiction between the detection performed by the CMLs and the humidity gauge, the decision whether fog was present in this area or not is based on the measurement of the humidity gauge at that point.

Tools

An application for 2D fog mapping was built in order to provide efficient way for generating fog map, which is user friendly. The application uses the links data provided by the operators, satellite image (we use it as a row data) and information from station of the Israeli metrological service widely spread in Israel. The application output is a 2D fog map drawn on the map of the requested area. The application also provided information regarding the links and IMS stations on the map display.

Fog Mapping Tool

The Fog map tool run on MATLAB, this is user friendly GUI for generating 2D fog map for specific time slot. The user first select file of the provider cells data, this file consist of the links parameters as: link-ID, location, frequency, height, etc.

Each provider has its own format for the cells data.

The next stage is to select the links data relevant for the observed event in time; the file contains the RSL measurement for each link, which captured during several times period.

The final stage in the links panel is to select how the links will divided in the pre-defined pixels, one option is to divide the links to a fixed number of points the second option is to divide the links by configurable length.

Side Information Integration

The Israel Metrological Service (IMS) provides extensive metrological measurements from all across Israel. We aim to integrate the IMS measurements as side information for the fog-mapping tool. When fog is presence the humidity percentage in the air is very high, can be more than 97%. In order to verify that the observed pixel detected a valid foggy area we would verify it by the nearest IMS station located inside the pixel. The IMS stations deployment provide a spread coverage across Israel and provide some extra measurement pixels for enhanced coverage. The additional benefit of using the IMS measurements is to rule out precipitation performed attenuation in the receive signal level.

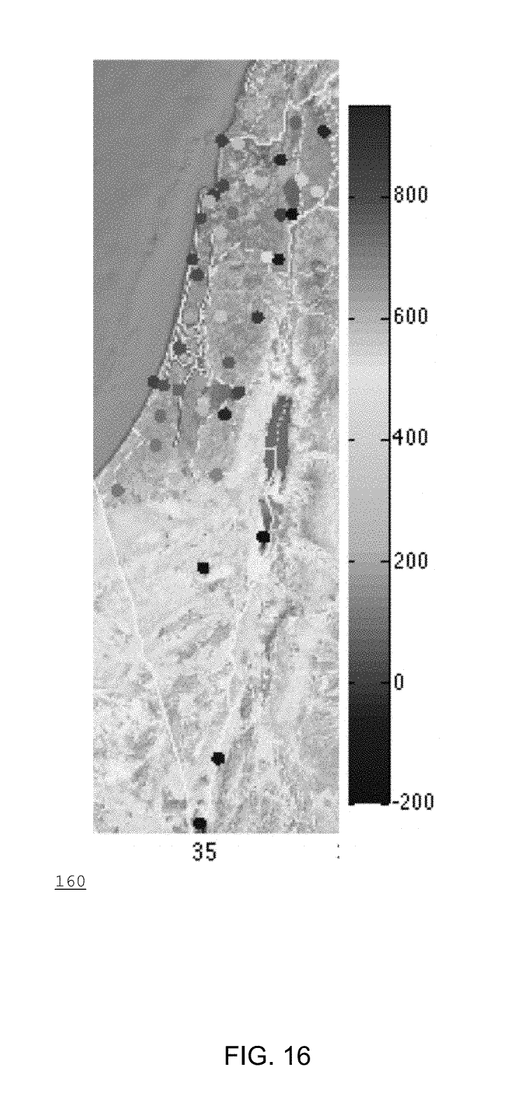

FIG. 16 presents a map 160 of the IMS station widely spread in Israel area, the total number of stations provide measurements is 81. The color map indicate the height above sea level of the IMS stations.

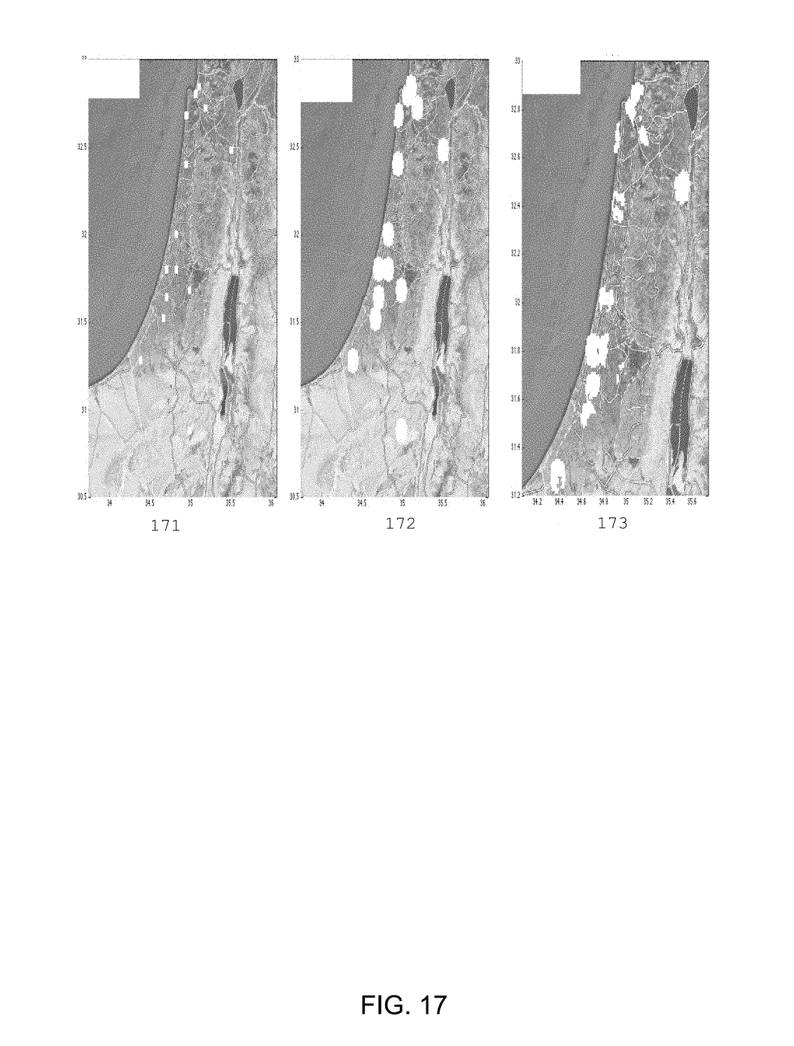

Graph 171 of FIG. 17 present the IMS stations location which measured humidity above 93 percent on Dec. 10, 2005. From 81 available IMS stations, 14 stations reported on humidity that indicate that fog was presence in that area.

Graph 172 of FIG. 17 illustrate the extrapolated map generated using the kernel described in Error! Reference source not found.

Graph 173 of FIG. 17 present the results of the topographic data inclusion as described in previous chapter.

Satellite

Usually, when there is no high cloudiness (low stratus clouds, found at higher levels off the surface) the satellite image can served as a reliable source for fog monitoring. We are using the satellite image for spatial fitting between the satellite and the MLs detected pixels. For spatial fitting, we processing the image provided by the CAPSAT to binary image which ‘1’ value represent fog presence and ‘0’ otherwise.

The parameters for predefined color scheme of the night microphysical are:

| Red | | | | Green | | | | Blue | | | |
|---|---|---|---|---|---|---|---|---|---|---|---|
| Channel | Min | Max | Stretch | Channel | Min | Max | Stretch | Channel | Min | Max | Stretch |
| IR12.0- | −4K | 2K | 1 | IR10.8- | 0K | 6K | 2 | IR10.8 | 243K | 293K | 1 |
| IR10.8 | | | | IR3.9 | | | | | | | |

The RGB recipes assign specific IR channels for channel differences to red (R), green (G), and blue (B) colors as single byte values, using predetermined thresholds, according to

$$( R , G , B ) = 255 \cdot {[ \frac{( TB , Δ TB ) - MIN}{MAX - MIN} ]}^{\frac{1}{{γ}_{R , G , B}}} \qquad ( 23 )$$

Where (TB, ΔTB) is the brightness temperature or brightness temperature difference (BTD) respectively, MAX is the upper threshold value, MIN is the lower threshold value and γ is the gamma enhancement value.

Typical physical values (temperatures) and the RGB color for different objects in the color schemes (T and BTD in degrees Celsius).

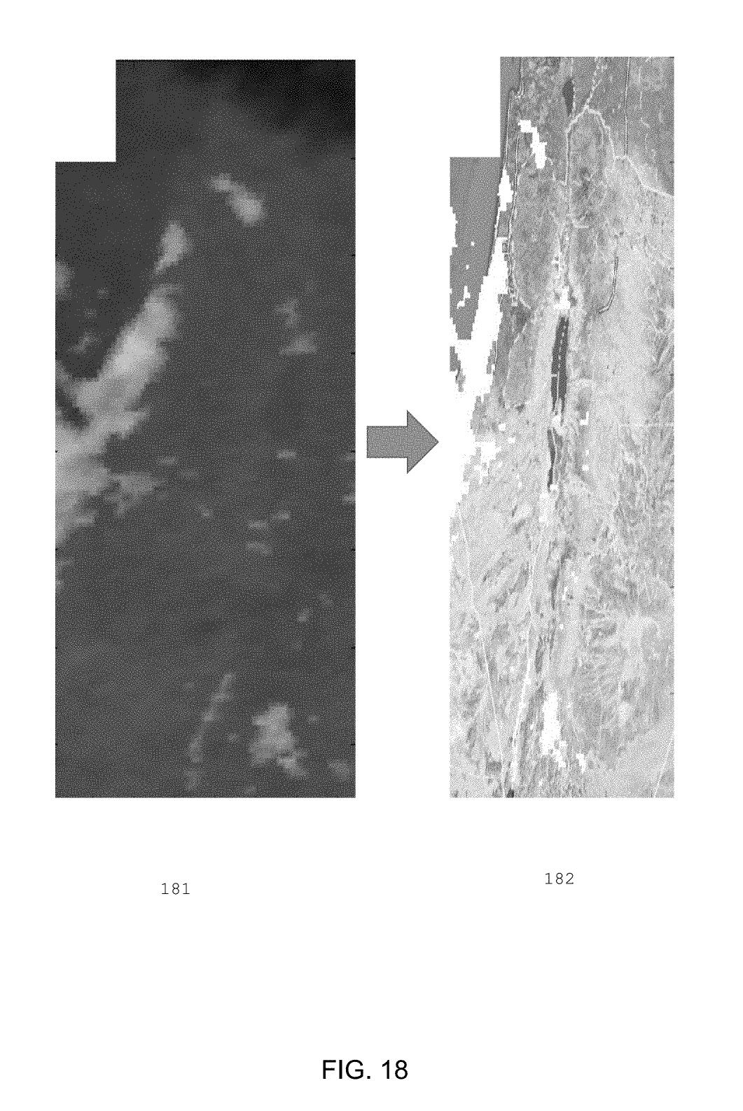

Map 181 of FIG. 18 presets the RGB image produce from the CAPSAT data on the night of Dec. 10, 2005, the RGB values calculated according to Eq 23. One can see a heavy fog along the coastal plain presented at that night. Map 182 of FIG. 18 presents the binary image generated from the RGB data according to the table in

⋅

Model Based Extrapolation-Extrapolate Fog Map Based on Topographic Data

The topographic data provide information for pixel extrapolation at two manners. The inclusion of each feature is optional.

Inversion

Temperature inversion is a reversal of the normal behavior of temperature in the region of atmospheric nearest to surface. A layer of cool air at the surface is overlain by a layer of warmer air, under normal condition air temperature usually decreases with height. A ground inversion develops when air is cooled by contact with a colder surface until it becomes cooler than the overlying of the atmosphere; this occurs most often on clear nights.

When the ground cools off rapidly by radiation. If the temperature of surface air drops below its dew point, fog may result.

Topography greatly effects the magnitude of ground inversions. If the land is rolling or hilly, the cold air formed on the higher land surfaces tend to drain into the hollows, producing a larger and thicker inversion above low ground and little non-above higher elevations.

Fog typically develops below a temperature inversion layer or within a ground temperature inversion layer. Accordingly—when temperature inversion information is available (where temperature inversion occurs)—this can be taken into account when determining that there is a fog. For example—if an inversion layer is located at a certain height and the microwave links propagate above the inversion layer—the measurements related to these microwave links should not indicate of an existence of a fog. Furthermore—knowing that certain microwave links do not pass through a fog may be used to calibrate wet antenna attenuation and/or be used to evaluate the reliability of fog related decisions made in relation to these microwave links.

Water Filling

For fog detected in valleys, we assume that the fog trapped, and it can be extrapolated base on the water filling principle. As water, finds its level even when filled in one part of a vessel, several pixels detected a fog extrapolated to a wider area.

The pixels that located in area around the detected one should comply with the next conditions: their height is equal or less than the detected pixel height and it located in range of the effective influence radius.

Experimental Results

Generating 2D Fog Maps

The presented tool in this work generate as a baseline 2D fog map across Israel area. We aim to present several event took place in Israel in the past years, some of them were very extreme with regards to the fog presence and some were lighter.

Case 1: 9-10 Dec. 2005

Between the late evening of 9 Dec. 2005 and the morning hours of the next day, a heavy fog front passing through central Israel was recorded by different observation techniques found in the area. At the surface, a ridge from the west with weak westerlies (and a long fetch over the Mediterranean Sea) was accompanied by a deep ridge aloft, which was causing significant subsidence.

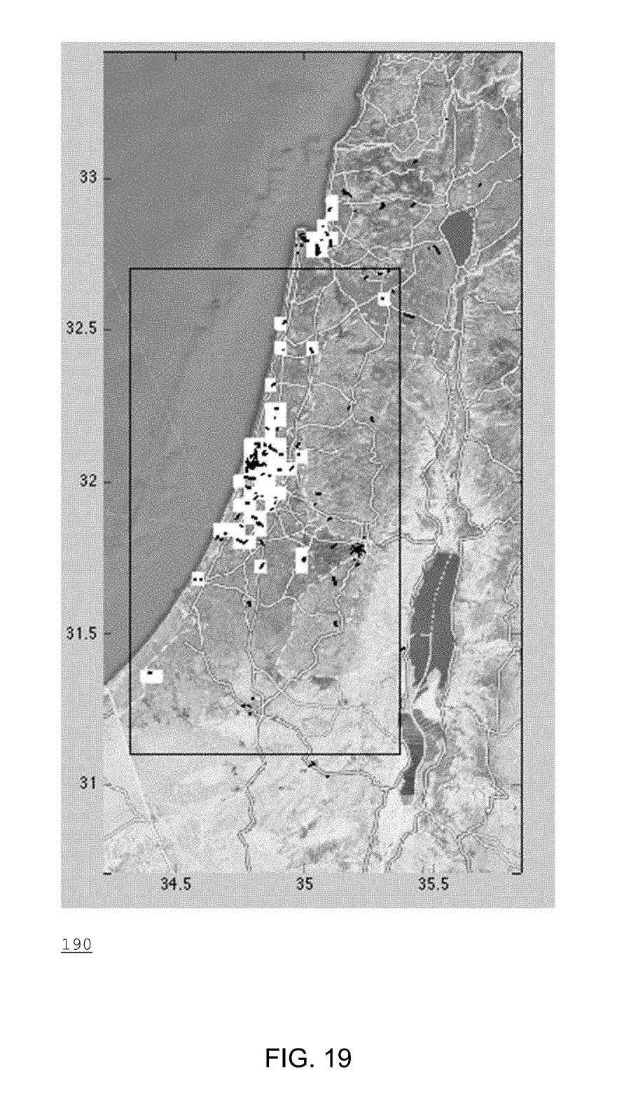

The microwave system used in this event comprised 382 links of lengths between 110 meters and 4.4 kilometers that operated in the frequency range between 37 and 39 GHz. The links were installed at elevations between −300 and 1000 meters ASL. The link system used provided measurements from the country wide region between the hours of 01:00 and 02:00 (all times Universal Time Coordinated) during the night of the event, and the fog map 191 presented in FIG. 19 was created based on the entire set of measurements from this time period. It shows the deployment of the MWLs used in this event. The areas indicated in white are locations where fog was detected by the microwave network based on stage 1 of the method only, i.e. the link measurements, without taking into account the topography of the area. The rectangle marked on the next figures indicates the bounded area where the comparison was made. The pixel resolution in the next figures set to be 4 km².

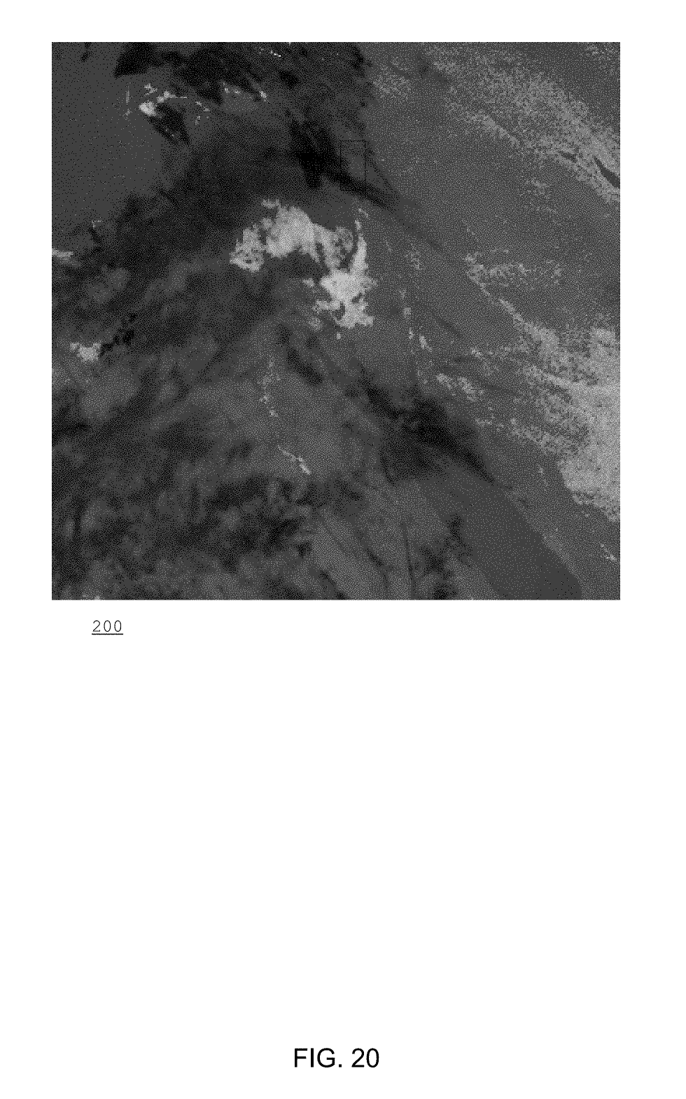

FIG. 20 includes an image 200 that was taken by Meteosat Second Generation (MSG) at 01:27 on 10 Dec. 2005. The wide fog front (tens of kilometers in scale) is indicated in the image in white. The square (black) indicates the area we focused on in our research.

We would like to illustrate the advantage of using ML for fog detection application. If we zoom in to the mount Carmel foothills we can see that the MLs and humidity stations measured attenuation and high humidity (100%) respectively.

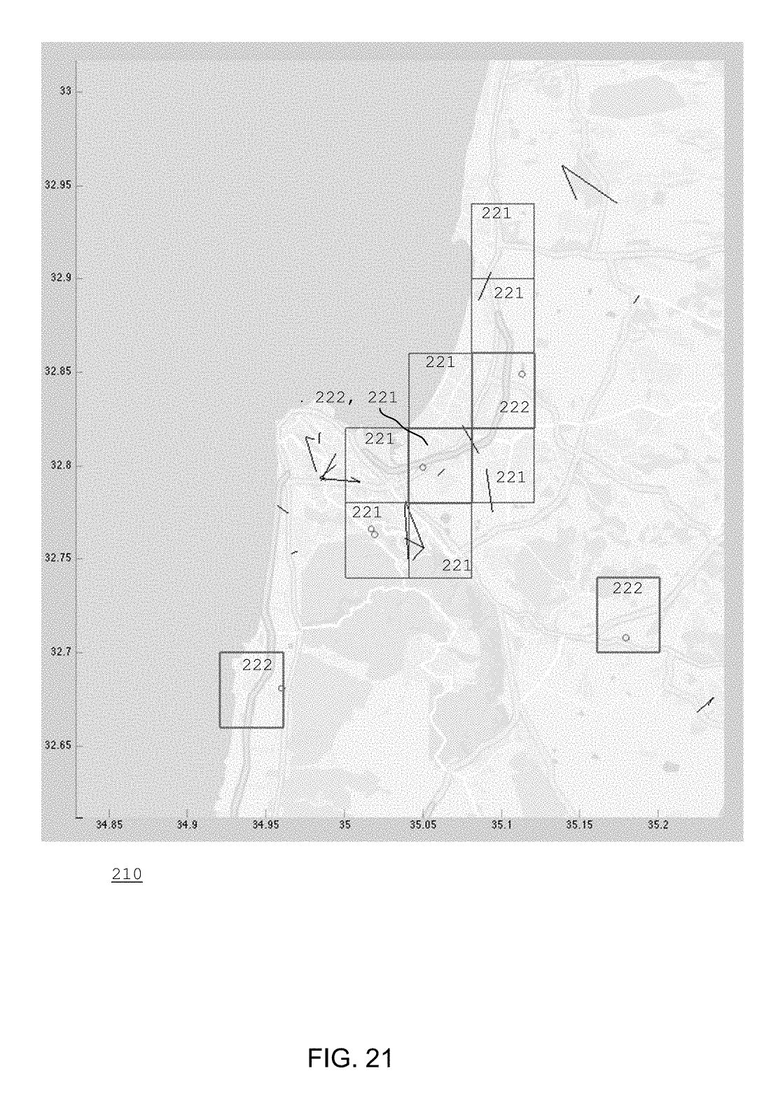

Map 210 of FIG. 21 the measurements of the microwave system, rectangles 221 indicate location were for fog was detected by microwave links and the rectangles 222, 221 indicate location were the humidity station measured humidity higher than 93%.

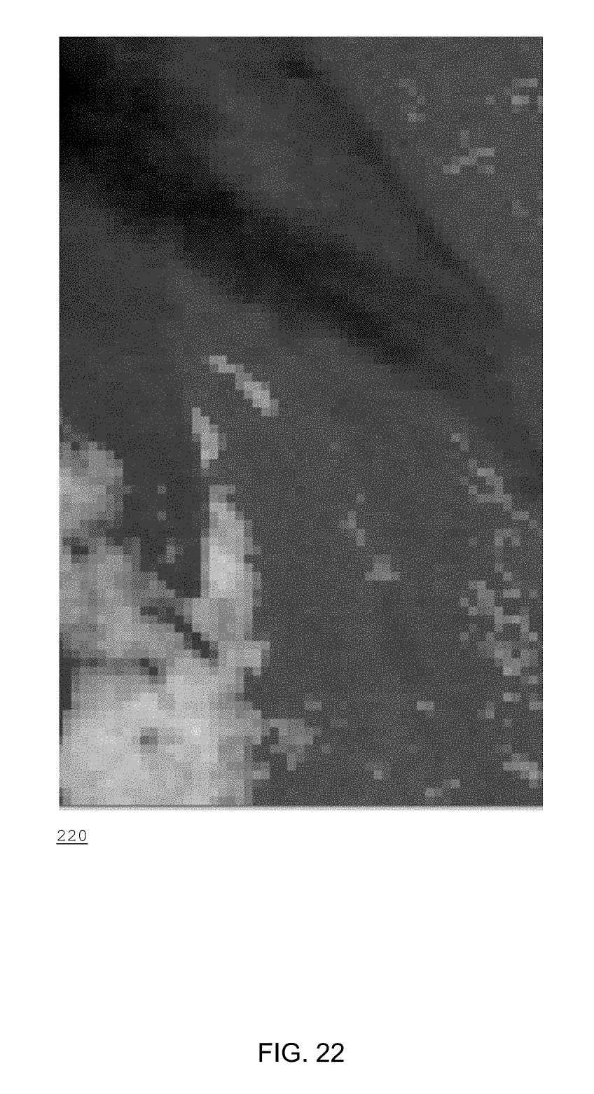

Compare to the detection by the microwave links, the satellite (see map 220 of FIG. 22) has difficulty to observe for at the ground level due to high or middle altitude clouds along the line of sight between the ground and the satellite system. The described analysis emphasis the advantage of fog detection by microwave links as they are less sensitivity to high or middle altitude clouds.

For reference we used measurements from Dec. 15, 2005—a non-foggy night.

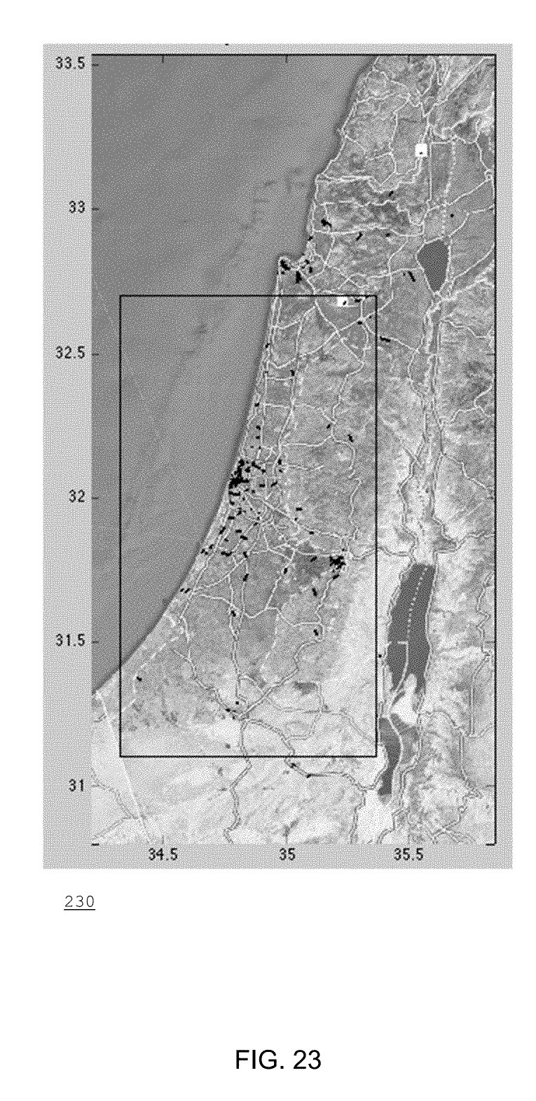

Map 230 of FIG. 23 shows the measurements of the microwave system. White pixels indicate locations where fog was detected by the microwave network and black lines indicate the links location. You can see that except of two pixels there were detect as fog pixels, almost all links didn't detect fog. The results shows that the suggested method has low false alarm in detection.

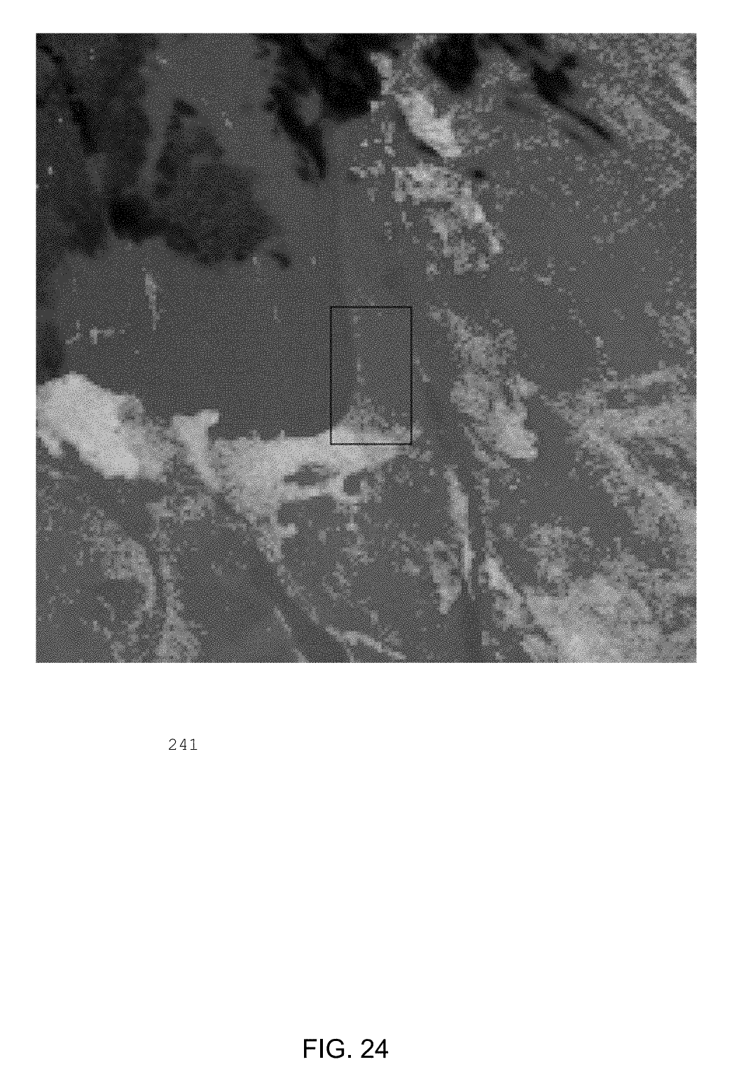

FIG. 24 presents an MSG image 240 from 15 Dec. 2005 at 01:00 UTC which was generated using CAPSAT. According to the CAPSAT software, if fog exists in a certain area it is indicated as a white shadow, which does not show up in the observed area. It can be seen that aside from a few singular pixels marked in white, the system did not detect fog on this night. The satellite image confirms that, in fact, there was no fog in the area at this time. Measurements which were taken from additional non-foggy nights acquired results of similar trend.

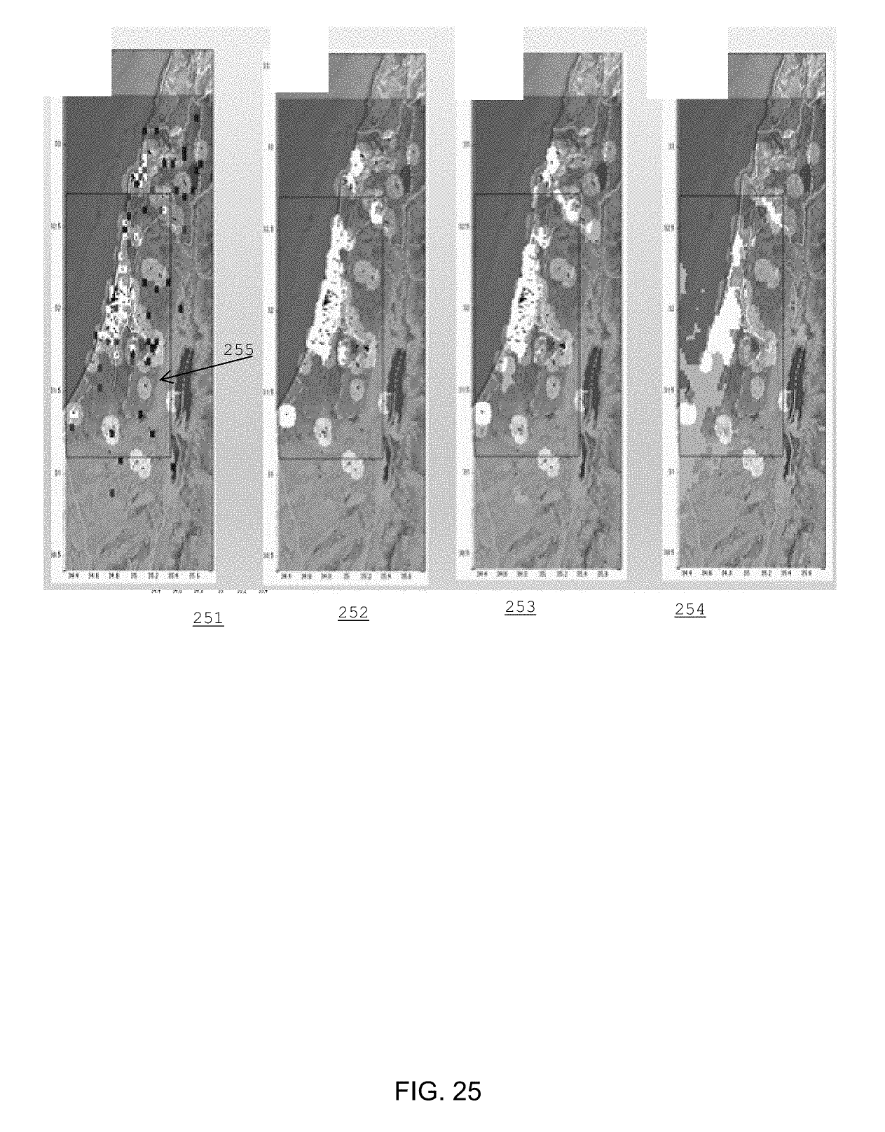

FIG. 25 includes maps 251, 252, 253 and 254. Maps 251, 252 and 253 show fog detection based on layers I, II and III of the method, accordingly. Map 254 presents the results of satellite detection. Comparison of the performance of the method was done in areas where CMLs are deployed including the radius of influence around them. These areas are “high lightened”. An example of such a “high-lightened” area is indicated by the arrow 255 shown in map 251. The rectangles in map 251 indicate the locations of humidity gauges that measured RH greater than 93% (red), and less than 93% (blue) at 01:00 UTC. The white pixels in each figure indicate areas where fog was detected by each of the techniques. The areas in gray represent locations where no CMLs are deployed and which are therefore excluded from the comparison (in these areas fog was detected by humidity gauges (map 253) and by the satellite (map 254).

The next stage of the method is to extrapolate the fog map based on topographic data.

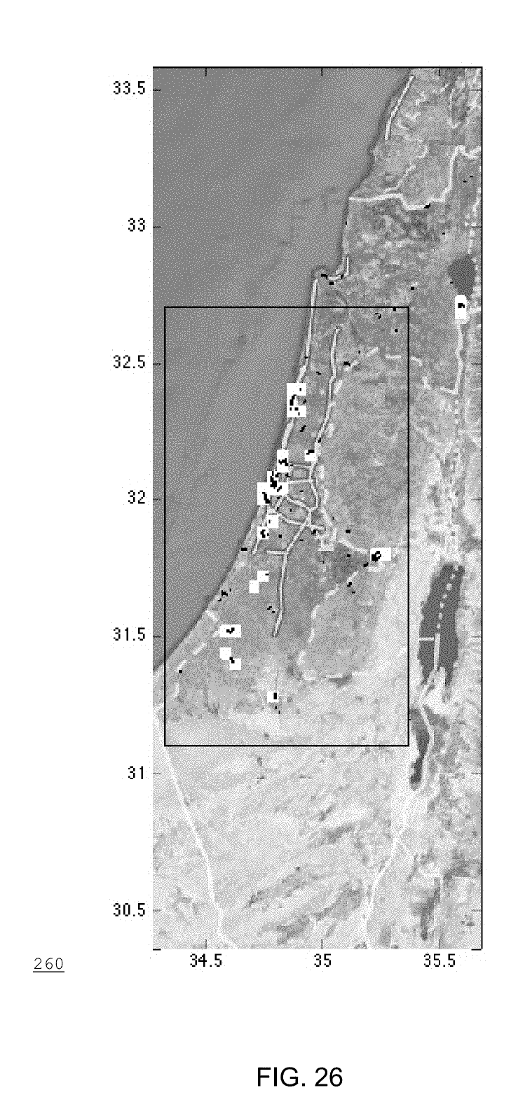

Map 261 of FIG. 26 represent the fog map generated by the fog detection tool, the white pixels indicate that fog was observed on thus pixels. In addition the IMS stations were added to the plot, the blue pixels indicate the location of IMS stations were the humidity measurement on the event time was less than 93%.

The red pixels indicate location of IMS stations were the humidity measurement was higher or equal to 93%.

Map 262 of FIG. 26 represent the fog map for topographic data inclusion.

For the next stage in the method the IMS measurements were integrate to the decision method. We assume the humidity measurements can be served as ground true measurements therefore were treat them in that way.

The method works on the extrapolated fog map based on topographic data map 262 and the IMS measurements present in map 261. If the humidity measurement from the IMS station is higher or equal to 93%, the method extrapolated the pixel was detected by the IMS station based on topographic data.

If the humidity measurement is less than 93% and there is overlap between the IMS station location and the extrapolated fog map, the method mask all pixels were extrapolated from the origin pixel and also mask the origin pixel itself.

In other words, the extrapolated area of the pixels detected fog and overlap with IMS station which didn't detect collapse to the origin pixel and disappear from the fog map.

Map 263 of FIG. 26 is a fog map as a results of the described method above. It can be seen that the coverage was improved, and we decrease the false alarm compare to the fog map based on ML measurements only.

Map 264 of FIG. 26 is a fog map based on MSG images generated on the same time slot.

Case 2: 26-27 Feb. 2016

The network in this event comprises 101 links, of which 48 operated in the frequency range between 37 and 39 GHz, and 53 in the range between 21 and 23 GHz. The links are installed at elevations of −184 to 1196 meters ASL. The link network used provides a single measurement per day, at 22:00, and as a result, fog map 260 of FIG. 26 is a snap shot of the phenomenon in space at that hour.

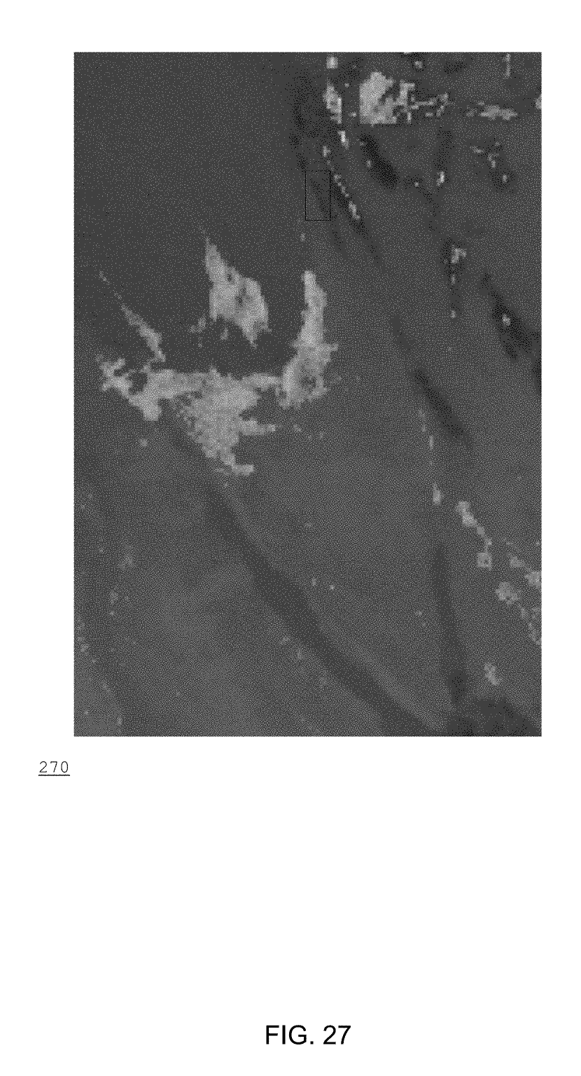

FIG. 27 includes an image 270 that was taken by Meteosat Second Generation (MSG) at 00:12 on 27 Feb. 2016. The wide fog front (tens of kilometers in scale) is indicated in the image in white. The square (black) indicates the area we focused on in our analysis.

We note that there are 16 MWLs deployed in the vicinity of the city of Jerusalem (31.8° N, 35.2° E in the figures) while only one link measured additional attenuation compared to the others. The measurement of this specific link in a concentrated area was considered outlier, and fog was not considered detected in the region.

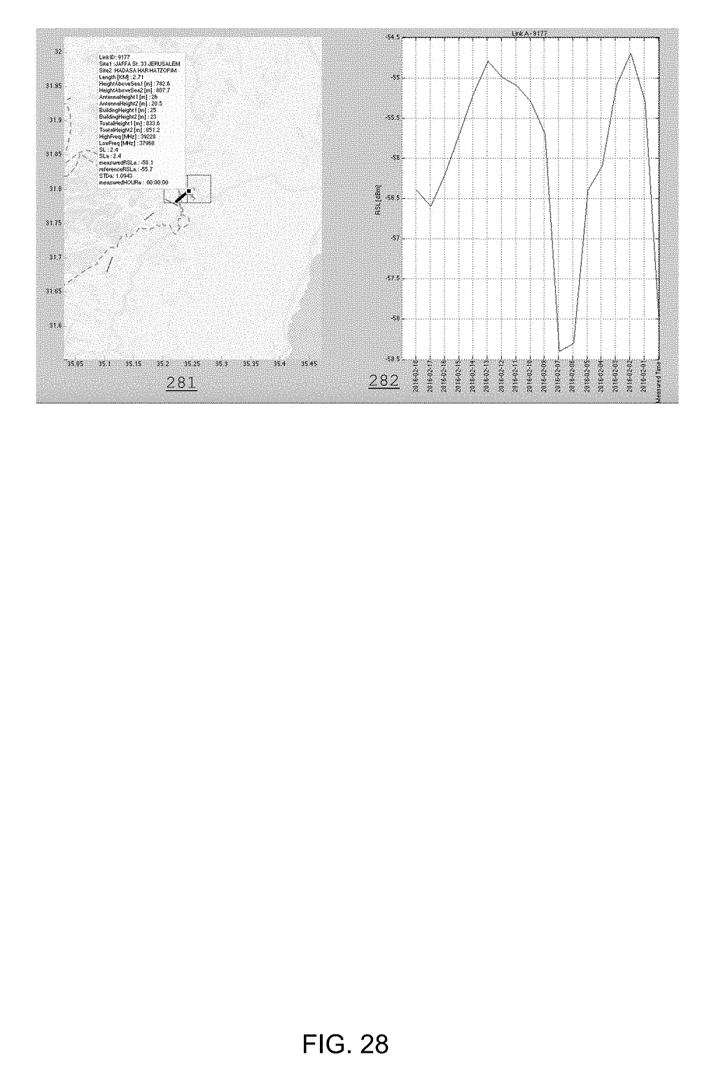

Map 281 of FIG. 28 illustrates a link, and graph 282 of FIG. 28 shows the RSL of the link. The link length is 2.71 km, the average height is ˜850 meters and the calculated attenuation based on reference measurements (Dry night) is 2.4 dB.

The suggested method s removes thus pixel using side information of the IMS station measurements.

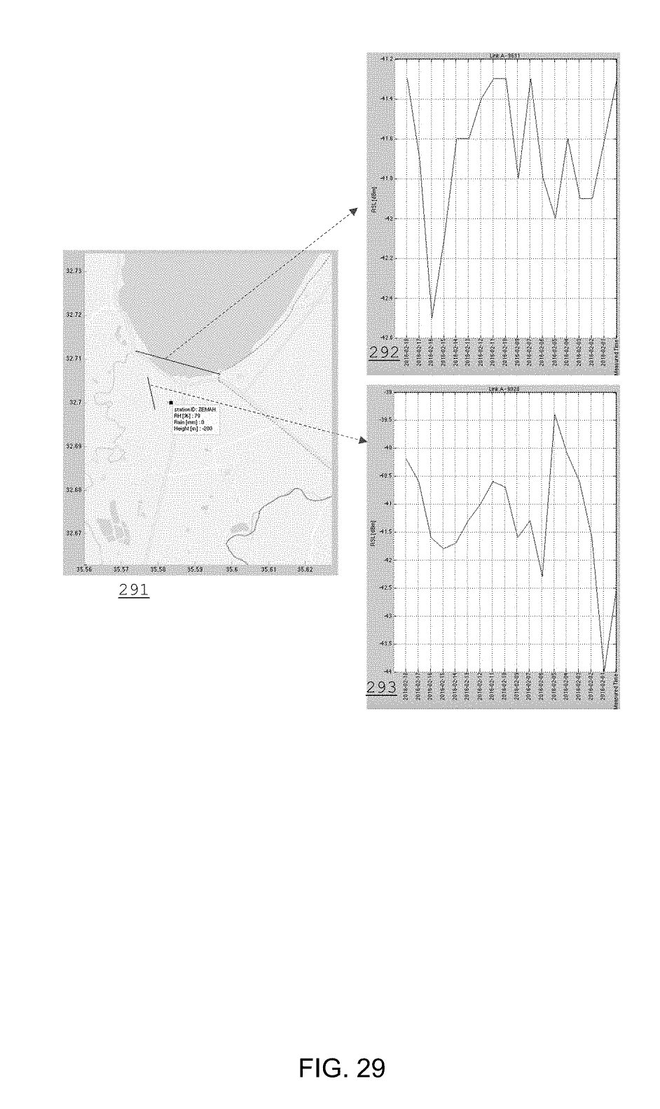

An additional case study is presented in FIG. 29, the observed area (see map 291) was at the south of the sea of Galilee. You can see measurements from two ML—map 292 from ML 9631 and map 293 from ML 9028), the length of the longer link is 2.25 km and the length of the second link is 850 meters, the height above surface for both of the links is −200 meters. The shorter link measured attenuation which yield to fog detection, the IMS station measured humidity of 79% indicate for non-fog area. This is an example for IMS measurements inclusion for false alarm decreasing.

The results show a convincing fit between fog mapping by a proprietary satellite platform and the proposed method.

Differences between the techniques are expected since there is a difference in the technical nature according to which the measurements were taken: ground level sensors spread across a large area with a predefined deployment and operating frequencies, vs. sampling taken from a great distance using frequencies and resolution specifically tailored for this purpose. Thus, future research could examine combining the different tools to achieve improved mapping capabilities. In some areas, the microwave system detected fog, while the satellite did not identify the phenomena in that location. This may arise from several different causes. First, it is possible that the detection of the microwave system was wrong at that specific location. This can occur from choosing a reference level that is not sufficiently precise for calculating the attenuation, from the microwave system's inherent quantizing error, as well as environmental conditions such as wetness on the microwave antennas caused by condensation during periods of high RH in areas where there was no fog. The method does approximate wet antenna attenuation and adjusts the measurements accordingly, but an insufficiently precise wet antenna approximation may cause false detection. On the other hand, there are possible cases, where the microwave system detected actual fog at a specific location in the observed area, while the satellite failed to detect it. This case is possible, for example, in areas of complex terrain, where the satellite cannot detect the fog from its angle of sight. Further research is required in these areas and they are left for future research.

In cases where additional fog monitoring instruments exist, those can be used in conjunction with the proposed method. Such data include, for example, RH measurements or inversion layer heights that provide important information about the development of fog. An additional future challenge is examining the ability of this method to detect fog in areas where there are no conventional methods for its detection, or decreasing the dependence on meteorological data (e.g. rain gauge information required to rule out precipitation). We note that the operating costs of our proposed method are relatively low since the commercial microwave networks are already deployed in the field and can be configured to store the data anyway—for network quality assurance reasons. Furthermore, these networks are already deployed in developing nations and rural areas where there are few environmental monitoring instruments available.

Thus, the proposed technique for fog mapping using existing commercial microwave networks has the potential to advance existing capabilities and improve the ability to contend with the dangers associated with fog.

Fog Monitoring Using e Band MWLs

In recent years, the common spectrum for commercial wireless networks' (CWN) microwave backhaul, offered frequency bands between around 6 GHz and 40 GHz, whilst each band utilizes several narrow-frequency channels of 50 Mhz at most, and supports data rates of up to 500 Mbps on a single carrier. Typically, the CWN systems consists of radio microwave links (MLs) that operate at K-band frequencies, are stretching over the length of hundreds of meters to tens of kilometers and installed at heights of up to few tens of meters Above Ground Level (AGL).

A growing demand for higher data rates and expanded bandwidth has led to recent development of CWN infrastructure towards backhaul MLs operating in the e band frequencies of 60-90 GHz. This newer technology allows throughput of Gbps on a single channel. The newly available commercial e band networks typically operate at spectrum segments of 71-76 GHz and/or 81-86 GHz and are best suited for MLs of less than 3 km in urban and suburban areas at most parts of the world.

An Ericsson e band ML designed for CWN backhaul use was installed between Ericsson Building at Mölndal, Sweden (Site A), and an apartment building near-by (Site B), with a line-of-sight of 1 [km]. The deployed ML can operate at either 71-76 GHz (low), or at 81-86 GHz (high) frequency bands, both in Vertical polarization. For the entire experiment duration, the lower 71-76 GHz RSL measurements have been recorded, with a quantization error of 0.03 [dB].

The e band ML was installed in 2009, and operated continuously until 2011, when Site B was dismantled, and reinstalled in another building near-by (Site C), creating a line-of-site of 1.35 [km]. The new ML setup continued to produce RSL measurements until 2014.

In addition, at Site A (Ericsson's Building), two weather sensors were installed: A standard rain-gauge, and an AirEye optical weather sensor, capable of monitoring the rain intensity, the snow intensity, the visibility, the ambient light and the rain drop size. The two weather sensors were installed roughly at the same height of the antenna (˜40 [m] above sea level (ASL)). Lastly, at spring 2013, a third weather sensor was installed, capable of monitoring additional phenomena, including the temperature [Celsius], the relative humidity [%] and the barometric pressure [hPa].

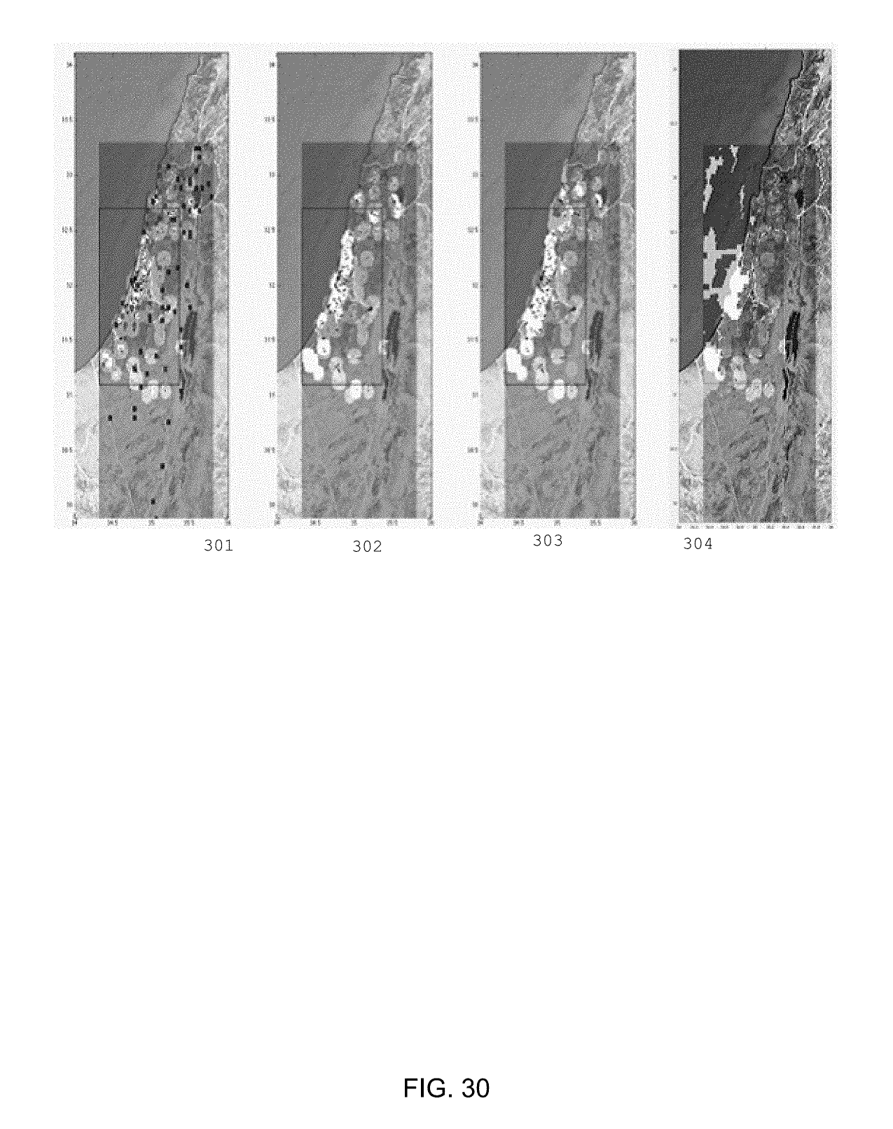

FIG. 30 illustrates four maps 301, 302, 303 and image 304. Maps 301, 302 and 303 are microwave-based maps and map 304 is a satellite-based image as taken by the MSG at 00:12 UTC. The area marked with an arrow in map 303 shows a region in which the surface was partly hidden from the satellite's perspective due to high cloudiness

The recorded weather data was logged in one-minute intervals, and the ML RSL measurements were recorded every 67 seconds until spring 2013, and every 10 seconds afterwards (the change was made due to internal software change made by Ericsson).

FIGS. 25 and 30 present the results of fog mapping using the developed method compared to satellite images. The areas in white indicate locations where fog was detected (by the algorithm, or the satellite).

Each of those figures include four maps, where maps 251, 252 and 253 as well as maps 301, 302 and 303 show the method results according to layers I through III, accordingly. Microwave link locations are indicated with black lines. Maps 251 and 301 depicts the deployment of the humidity gauges, where red and blue squares represent humidity gauges that measured RH 93%, or RH<93%, respectively.

Maps 254 and 304 shows the detection of fog/low stratus from MSG measurements taken during the same time frame as the link measurements. The satellite image was generated by the Clouds-aerosols-precipitation satellite analysis tool (CAPSAT) in night microphysical mode. The pixels where a low stratus was detected in the satellite image were transferred correctly onto maps 254 and 304.

In the following section (results analysis) we compared the performance of the algorithm to satellite imagery and humidity gauges in the areas where the links are deployed including the suitable radius of influence around them. These areas are “highlighted” in each figure (An example of such a domain is indicated by the green arrow in map 251). Regions colored gray are areas where fog was detected (by the satellite or the humidity gauges) but that do not contain CMLs, and thus were excluded from the comparison (and were not considered in the performance analysis stage).

The fog maps presented here (FIGS. 25 and 30) are those which were acquired using the centralized detection mode of the algorithm.

Fog Event from the Night Between May 7^{th} and 8^{th}, 2013

A ridge centered to the west of Israel, drove marine flows into the area during the day. During the night hours, the center of the ridge moved eastward, and settled over Israel, causing further subsidence of the marine inversion thus leading to the development of a dense fog front. FIG. 30 shows the performance of the microwave-based algorithm for fog detection against the satellite product from this event.

The microwave network used in this event comprises 235 links, which operated in the frequency range between 37 and 39 GHz. The links are installed at elevations of −337 to 1133 m ASL. The link network used provides a single instant measurement per day, at 00:00 UTC and, accordingly, the fog map that was generated is a snap shot of the phenomenon in space at that hour.

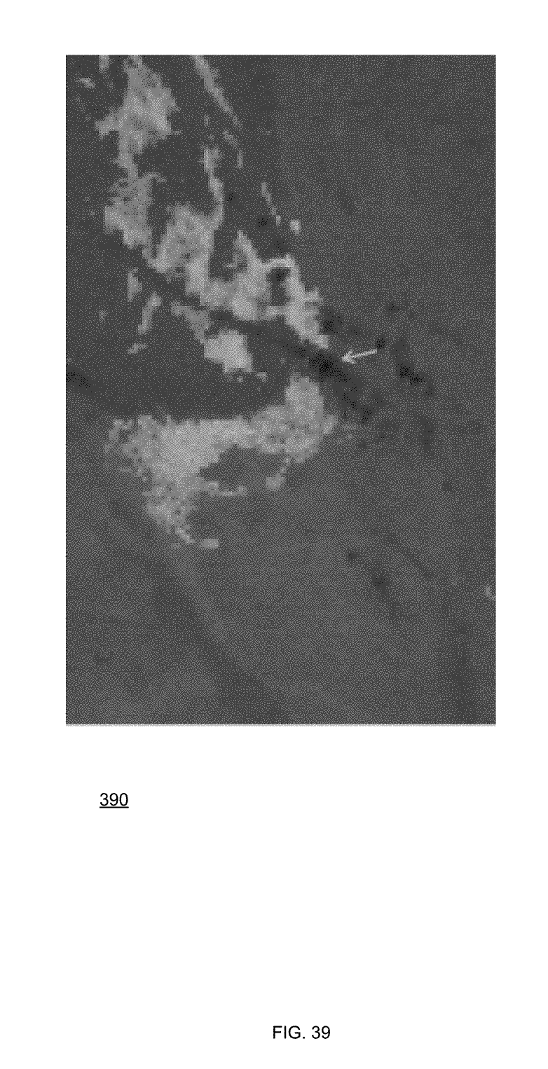

FIG. 39 shows the satellite image as produced by CAPSAT from the same fog event (at 00:12 UTC). The fog is displayed as a white shadow while the red shadow marked by the arrow shows high/middle altitude clouds that prevailed across the region and as a result may have concealed part of the fog patch from the satellite vantage point. Accordingly, map 304 (satellite image) does not show the detection of fog along this part of the inner Israeli coastal plain (The area marked with an arrow in map 304). On the other hand, one can note in map 303 that the microwave-based algorithm detected fog across the same domain. Thus, the difference between the satellite imagery and the product of the algorithm in this region may be due to the failure of the satellite to identify fog under such conditions. This scenario indicates the potential of the proposed technique to provide a response at times when satellites cannot, or alternatively, compensate for the satellite observations in places where it is prone to failure. A further discussion concerning this issue will be presented in the conclusions section.

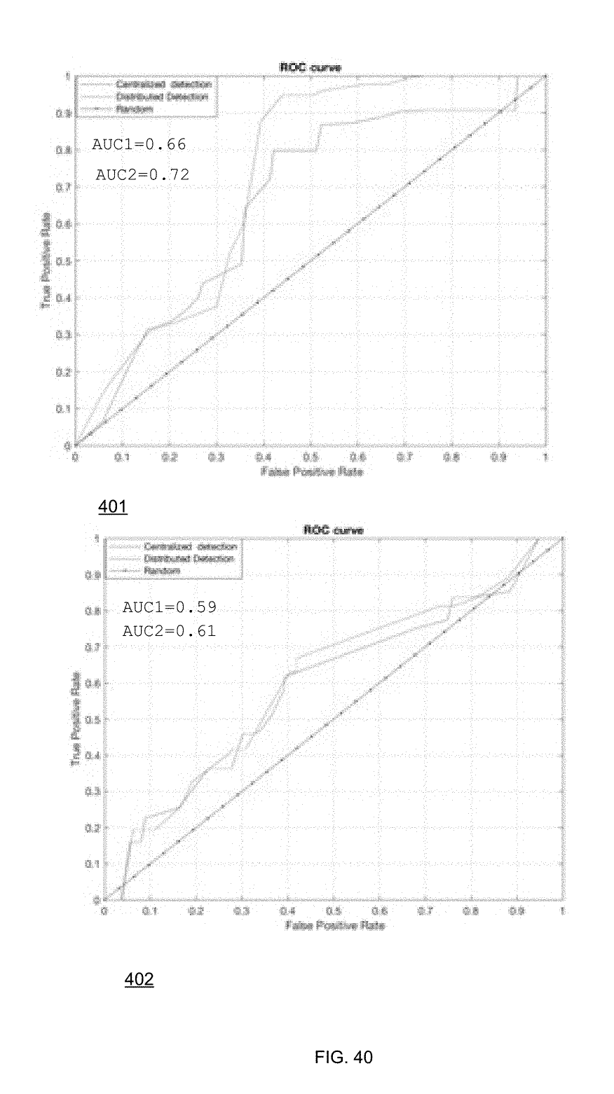

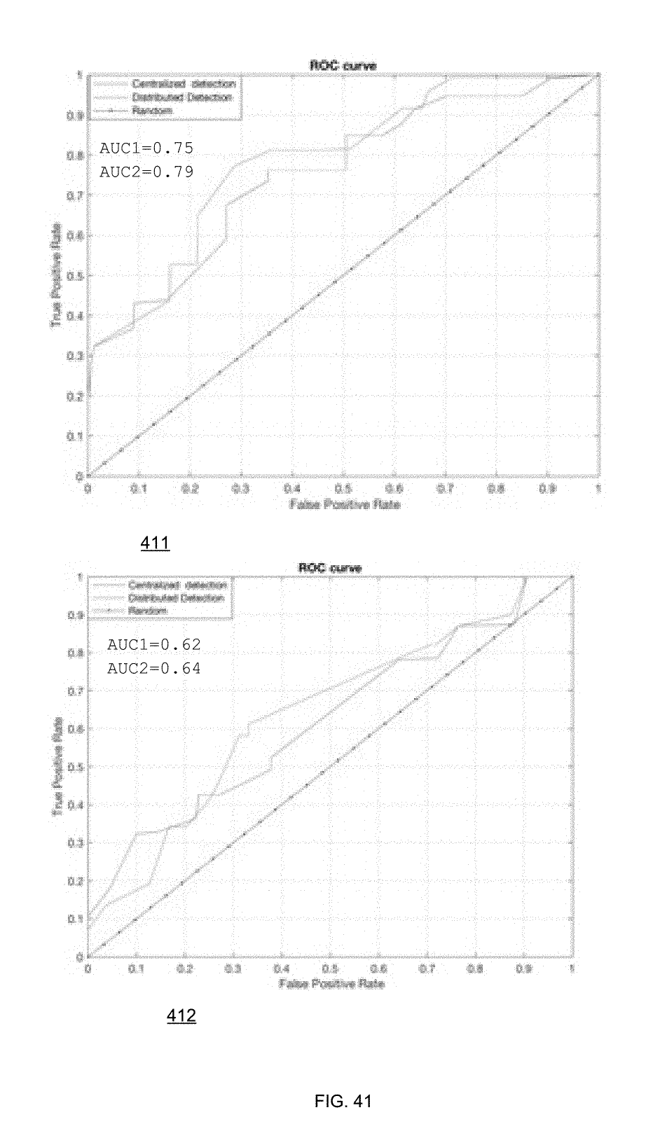

FIG. 40 shows Receiver Operating Characteristic (ROC) curves (Metz, 1978) that indicate the microwave technique's ability to detect fog.

Under the assumption that the instruments with which the proposed algorithm's performance is being compared (in this case satellite measurements and humidity gauges) constitute ground truth, the figure plots true positive rates against false positive rates for various threshold settings.

Graphs 401 and 402 present the ROC curves as they were calculated for the final algorithm product for fog events 2005 and 2013, respectively, when compared to the satellite observations for each event. Each panel contains two ROC curves calculated for centralized detection, and distributed detection of the algorithm. The ROCs were calculated by comparing all of the pixels located in the “highlighted” areas (shown in FIGS. 25 and 30) where CMLs where located and were covered by satellite observations as well.

The red line in each panel indicates the detector performance in case the decision was random (coin toss). The Area Under Curve (AUC), which indicates higher detection ability as the value approaches 1, is indicated at the top of each panel where AUC1 and AUC2 indicate the calculations carried out for centralized detection and distributed detection, respectively.

Similarly, graphs 411 and 412 present the ROC curves calculated for the three fog events compared to the measurements of the humidity gauges (as above, in the “highlighted” areas), where, under the prior knowledge that fog conditions existed in the entire region, it was assumed that once relative humidity was equal or greater than 93%, fog was identified at the location of the humidity gauge, and in the influence radius defined around it (in this research—5 kilometers).

The algorithm's performance when compared to the humidity gauge detection can be seen to be better than the performance when compared to the satellite products. The explanation for this observation possibly stems from the fact that the use of humidity gauge data was done under the prior knowledge that fog existed in the area, and since the humidity gauges are located in close physical proximity to the CMLs (particularly, when compared to the satellite, as illustrated, for example, in FIG. 39).

Microwave Measurements in Fog Prone Conditions

In this part of the research we compared the commercial microwave link attenuation measurements against the relative humidity measurements when RH 93% over a period of several months. The measurements presented here were taken during months that are prone to fog formation across this region. Accordingly, months from the periods from February to June, and November were chosen (from the years 2013, 2015, 2016).

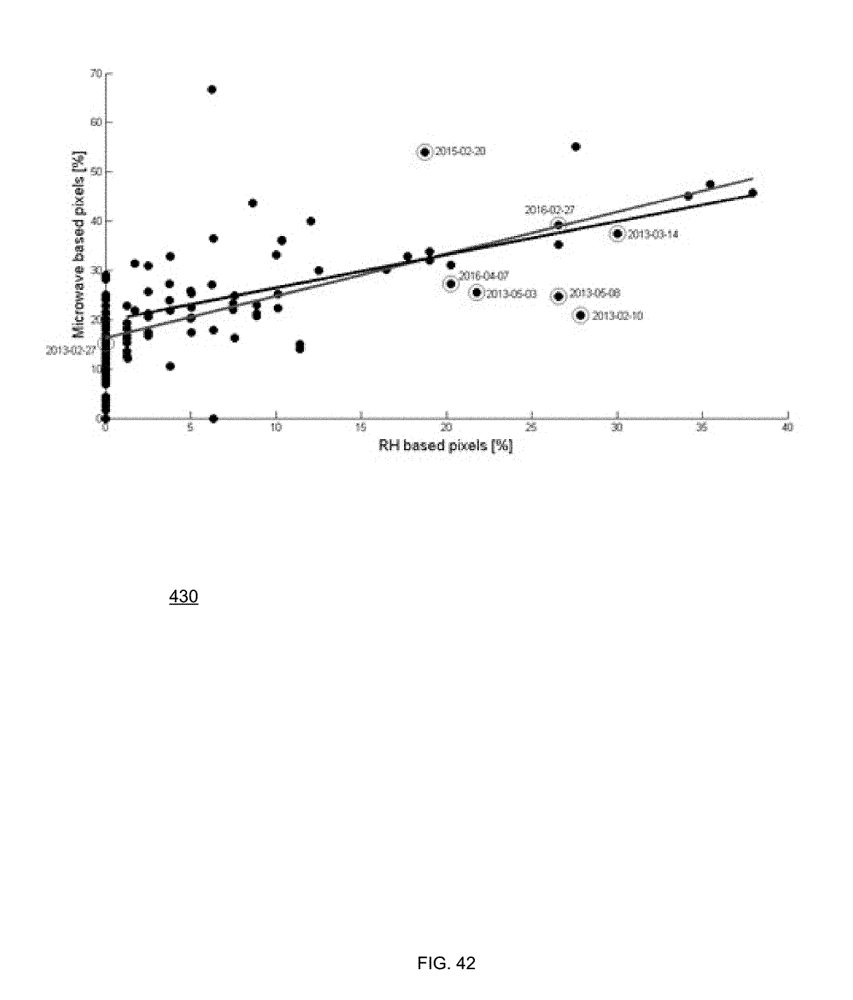

Based on the measurements from all of the CMLs deployed in a given space, a certain number of pixels can be generated in that area, where the existence or lack of added attenuation can be determined for each pixel. The y-axis in FIG. 42 represents the percentage of pixels out of the total number of pixels where the links across Israel measured increased attenuation greater than Q₁.

Analogously, based on the measurements of all of the humidity gauges deployed in a space, a certain number of pixels can be generated in that area, where it is possible to determine for each pixel whether RH was greater than 93% or not. The x-axis in FIG. 42 shows the percentage of pixels, out of all of the pixels generated across Israel, where RH greater than 93% was measured.

The fit between the percentages of the two measurement means (links/humidity gauges) can be seen. That is, generally, at times where the percentage of pixels registering high RH was greater, the percentage of pixels where increased attenuation was measured, was greater. The points with dates beside them indicate days where fog occurred across central Israel, a location from which human eye observations were available and according to which it was determined that there was fog across the area. Additional fog events may have occurred in other regions of the country and may appear on the graph. However, there were no direct ground truth observations of fog from these areas for verification.

Thus, of all the nights examined over several months, the microwave system showed the ability to detect the nights where high RH existed, including the nights were fog events occurred. Future research can investigate the ability to automatically detect fog events from the “cloud” of high RH/microwave attenuation measurements.

The linear fit in red was derived based on all measurement points (including those located on the y-axis). The effective linear fit, colored black, was made without considering the measurements located on the y-axis (which were considered outliers in this case), and, in this case the fit between the measurements of the humidity gauges and the links (the horizontal and vertical axes, respectively) was found to be higher. A correlation of 65% compared with 56%, respectively.

The points located on the y-axis of FIG. 42 indicated cases where increased attenuation was measured but relative humidity was lower than 93%. There are several possible reasons for the occurrence of such measurements, including for example, condensation accumulating on the microwave antennas in high relative humidity cases (that are still lower than 93%) or rain fall that did not induce RH greater than 93% in the area. Additionally, one specific fog event can be seen located on the y-axis. In this case, the RH measurements during the period where link measurements detected increased attenuation were lower than 93%, and humidity increased to higher levels in the later, dawn hours (and only then did fog occur). It is possible that the explanation for the increased attenuation observed prior to the fog event in this case was caused due to the effects of a temperature inversion that occurred in the area before fog occurred, causing anomalies in link measurements due to the non-standard changes in the atmospheric refractivity index.

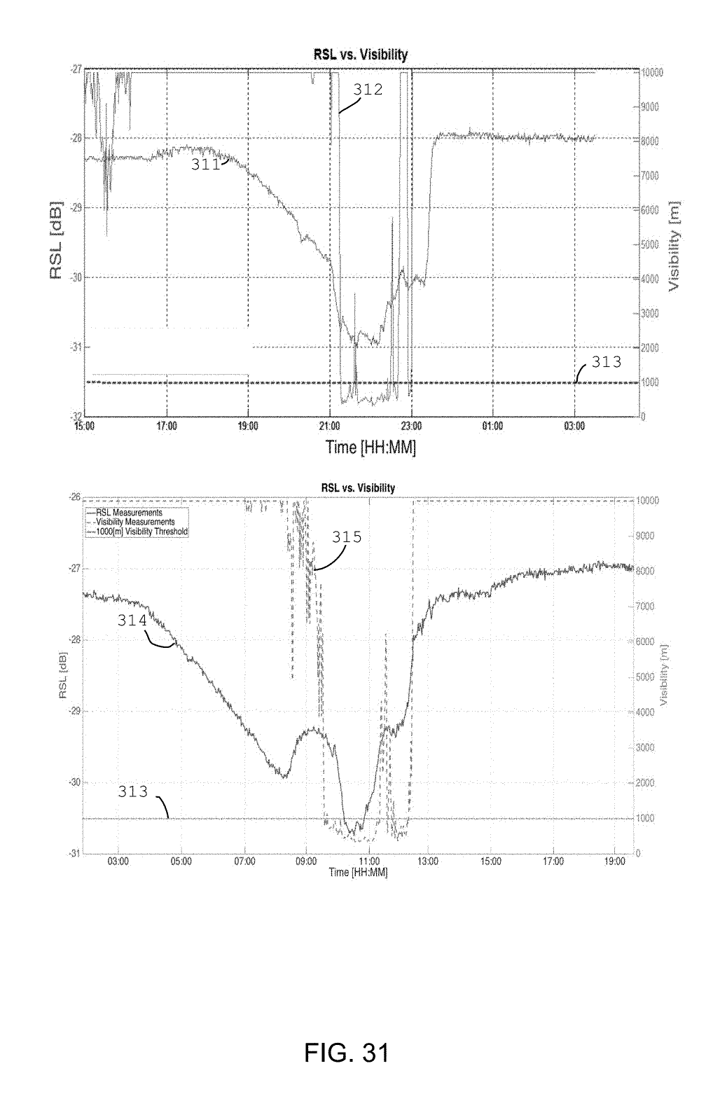

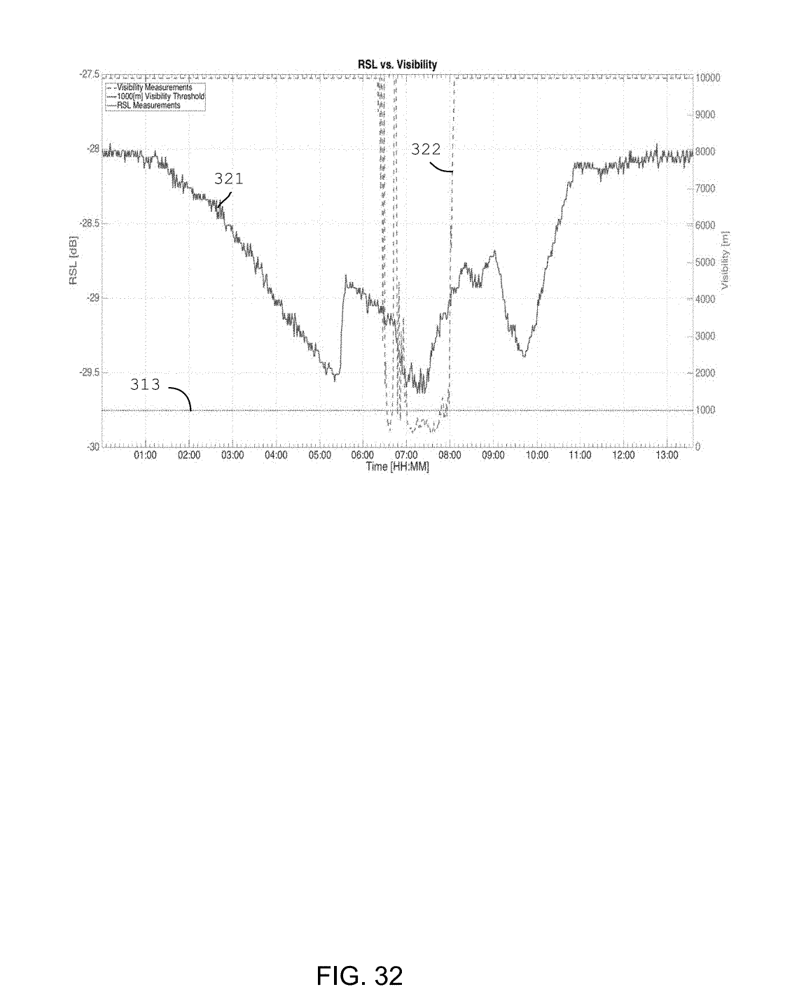

In FIGS. 31 and 32 the y-axis represents “Meteorological Optical Range”. The term “visibility” in the context of these figures is Meteorological Optical Range.

FIG. 31 Error! Reference source not found. presents RSL measurements taken by the e band microwave links (311 and 314) during fog events, detected by the visibility sensor (312 and 314) between 21:15 to 22:45 of 10 Mar. 2014 (top part of FIG. 31) and between 09:20 to 11:45 of 27 Dec. 2012 (bottom part of FIG. 31). Notably, a drop in RSL measured by the microwave link occurred, when visibility plummeted. Visibility threshold of 1000 meters is denoted 313.

FIG. 32 presents RSL measurements taken by the ML (321) during an additional fog event detected by the visibility sensor (322) between 06:40 to 08:00 of 11 Nov. 2013. According to the site rain gauge, no precipitation was recorded during all three events and therefore the possibility of rainfall induced attenuation was ruled out. Visibility threshold of 1000 meters is denoted 313.

However, we note that the RSL drop began prior to the visibility decrease, and the increase in RSL also lagged the increase in visibility. The possible explanations for this phenomenon are detailed in the conclusions and results analysis sections.

A comparison of the events described in FIGS. 31 and 32 shows that in FIG. 31 additional attenuation is observed close to time of the drop in visibility, that is, the RSL values measured in the time interval where fog existed (Visibility lower than 1 kilometer) are lower than those measured when the phenomenon did not exist. On the other hand, in the event presented in this FIG. 32 correspondence is not observed in the same extent.

That being said, we estimated the Liquid Water Content (LWC) for the fog events presented in FIG. 31. We used the visibility sensor measurements to determine the RSL baseline prior to the onset of fog. The baseline was taken to be the median of the RSL measurements taken 15 minutes before, and after the detection of fog by the visibility sensor in the time interval where a local minimum in RSL was observed. This value was subtracted from the RSL measurements to produce an attenuation measurement set.

Negative attenuation values (two or three places after the decimal point) were clipped to zero. LWC values were then calculated using eq. (4).

In order to calculate the LWC in the case of the 2014 event, we used available temperature measurements from the temperature sensor located in the area, that fluctuated between 1.5 and 2.5° C. (with relative humidity of 94%-95% which favored fog conditions). In the case of the 2012 event, no temperature data was available, and thus they were estimated. We assumed a temperature range (high and low boundary values) based on temperature measurements taken by the temperature gauge in the calendar dates adjacent to that of the event, and during the same hours of the day, but from years where temperature data was available (2013, 2014). The temperature range found for the event using this approach was between −5 and 10° C.

The values calculated, for the 10 Mar. 2014 event, were found to be in the range between 0 and 0.2 gr/m³, with a median of 0.15 gr/m³.

The LWC values calculated for the entire range of temperatures estimated for the 2012 event were found to be in the range of 0-0.5 gr/m³. The median values were found to be 0.14 and 0.17 gr/m³ using the eq. (4) for the higher temperature (10° C.) and the lower temperature (−5° C.) respectively.

These LWC values are common to fog and match the values measured by proprietary equipment in prior field research.

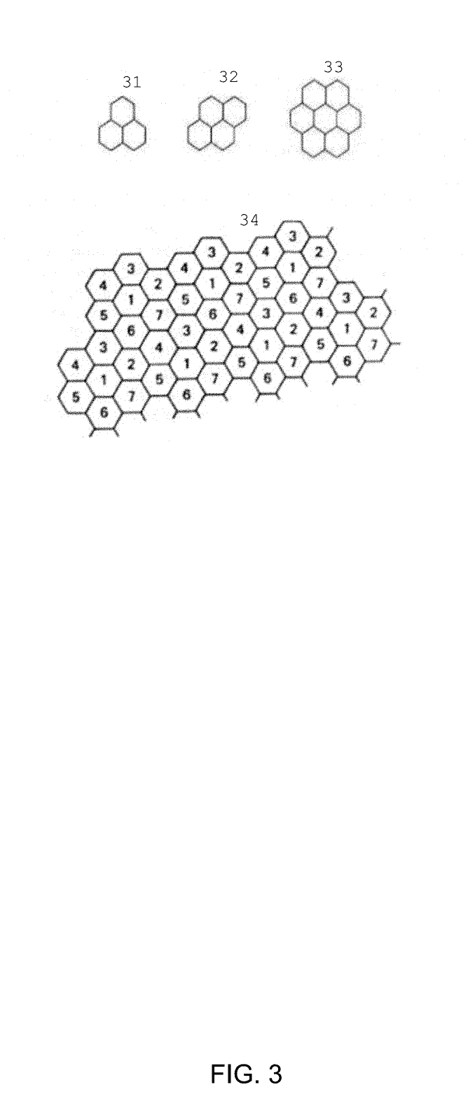

The measurement results shown in FIG. 3 demonstrate the complexity that might arise in certain cases in determining a reference baseline even at times where additional side data is available (e.g. visibility sensor). Accordingly, in this event, the LWC were not estimated, and additional research is required on this topic, as we discuss below.

In addition, a somewhat similar effect can be seen prior to the detection of fog, were, prior to the visibility drop, a slow increase of the attenuation can be seen (see FIG. 2 and FIG. 3). This effect may also be connected to water droplets accumulated on the antenna radome, as well as the increase in the air humidity levels or additional possible effects. Although, one can estimate the LWC in certain situations (as in FIG. 2), where the attenuation level prior to and after the fog event can be estimated using, for example, side information as demonstrated here (FIG. 2). On the other hand, estimating the reference baseline in FIG. 3 is more difficult, because no additional RSL loss can be detected simultaneously with the decrease in visibility, and because the attenuation measured by the link does not form a local minimum as was the case in the prior events shown in FIG. 2.

A possible reason for these results might be that the fog, demonstrated in FIG. 3, did not develop to the same extent as previous cases, and thus covered only a part of the link during part of the period, and did not cover the visibility sensor. Another possibility is that other phenomena, such as wet antennas, were more dominant when compared to the fog, that was relatively lighter. More research is required on this issue in future work. It may be, that once higher e band frequencies are used, as the wavelength of the radiated signals is shorter than the current K-band one, the current models for WA, which approximate the water to a thin layer covering the antenna's radome, is no longer valid. We believe that the actual shape of the water droplets, including the change in size of those droplets during the drying period may needed to be taken into account.

Environmental monitoring using existing K-band CWN MLs is a developing field, and, due to its potential, has gained much interest in the past decade. Multiple methodologies have been shown to exploit the standard RSL measurements recorded by the cellular operators, and use them in order to detect and estimate precipitation (mainly rain and sleet). Recent studies have started to deal with the potential of MLs to monitor other than rain phenomena, particularly including fog and humidity. In this manuscript, we have presented for the first time quantitative results using some of the mentioned methodologies, including accumulated rainfall estimation, and LWC estimation, using RSL measurements recorded by a future e band CWN ML.

The e band CWN increased sensitivity to the physical phenomena containing water and oxygen has a big potential as opportunistic environmental monitoring tools. But, on the other hand, this increased sensitivity raises new challenges both in modeling and in signal processing. During this current research, we often found that current assumptions made on the K-band MLs cannot be directly used on the future E band MLs. Especially, we have shown that rain may not be the sole dominant factor, and thus, other factors such as WA, and even fog and humidity may interfere with current rain-rate and accumulated rainfall estimation methodologies. It may be, that further and more advanced approaches of estimation should be developed, before accurate rain-rate and/or accumulated rainfall results could become available using e band based RSL measurements.

Indeed, the future e band CWN deployment may boost environmental monitoring possibilities twice fold: first, due to the physical propagation of the higher frequencies signals, the maximum length of a reliable transmission is shorter (compared to the K-band system) and would require shorter MLs to be deployed. This fact will increase the number of links, and in turn increase the overall resolution of RSL measurements. Second, as is presented in FIG. 1 (in the Introduction) and validated in the presented results, there are physical phenomena such as fog, which disturb the e band range to a much greater impact that the K-band, and thus, can be easier detected and/or estimated.

Prior research examined the effect of fog on microwave systems in an effort to understand the interference it caused on the links and improve performance for communication needs. For example, research that examined the issue through a test link (not a commercial link) operating at a frequency of 72.5 GHz found attenuation over the link during the time period that matched the beginning of the fog event. The LWC calculated according to link measurements, 0.14 gr/m³, is typical for fog events, and fit an additional measurement taken using an instrument for estimating LWC located in the area (the instrument that was calibrated using the link measurements). The approach in these papers treated fog as an interfering phenomenon affecting the performance of the communication system. The concept of using fog induced attenuation in order to monitor the phenomenon using commercial microwave systems was demonstrated recently. In the cases examined in this paper, the LWC values calculated are typical in fog events, but the difficulty in detecting the attenuation baseline can be seen. Attenuation was detected on the links at time periods that do not always match the measurements of the visibility sensor. This discrepancy can arise from a number of different factors that can cause additional attenuation—such as, water droplets accruing on the microwave antennas prior to the onset of fog due to condensation, changes in humidity, temperature fluctuations that affect the analog circuits in the system, and more. Furthermore, the visibility sensor provides a point measurement, whereas the link provides a measurement along a linear path, thus, the differences in the ability to measure the phenomenon in space might cause additional differences in the timing of the observations. On the other hand, the data used in the cases shown here, was taken from a single link, whereas in typical configurations, links are deployed in high concentration over the terrain, and thus measurements from a large number of links can be utilized to improve performance. Further research is required on this point.

To conclude, we believe that the unavoidable move to the e band range of frequencies for CWN use holds great potential and opportunities, and should enhance future environmental monitoring possibilities. However, the current detection and estimation methodologies which have been tested and used mainly on the K-band frequency range, may not be implemented on the future e band CWN directly. Further research is needed, as part of the assumptions used on the K-band range may need to be revised for e band range use, and, in turn, may require dealing with new estimation challenges.

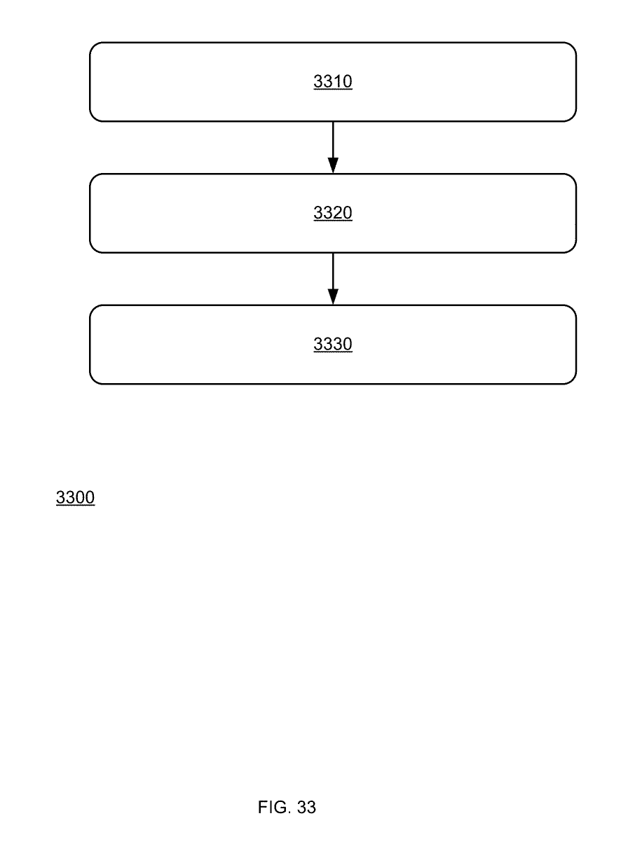

FIGS. 33-38 illustrates methods for generating a two-dimensional fog map of a region from a near-ground sensors network of commercial microwave links that are spread within multiple pixels (locations) of the region. Examples of the various steps of these figures can be found in the text above.

FIG. 33 illustrates a method 3300 for generating a two-dimensional fog map of a region.

Method 3300 may include a sequence of steps 3310, 3320 and 3330.

Steps 3310 may include extracting information about commercial microwave links attenuations from received signals levels of commercial microwave links. The commercial microwave links may be spread within multiple pixels of the region.

Step 3320 may include deciding on an existence of fog within at least one pixel of the multiple pixels based on (a) the commercial microwave links attenuations, and (b) a mapping between the commercial microwave links and the multiple pixels.

Step 3330 may include generating the two-dimensional fog map of the region based on the existence of fog within at least one pixel of the multiple pixels.

Step 3330 may include interpolating information about the at least one pixel.

Step 3330 may be responsive to information obtained by one or more other sensors that differ from microwave radiation sensors.

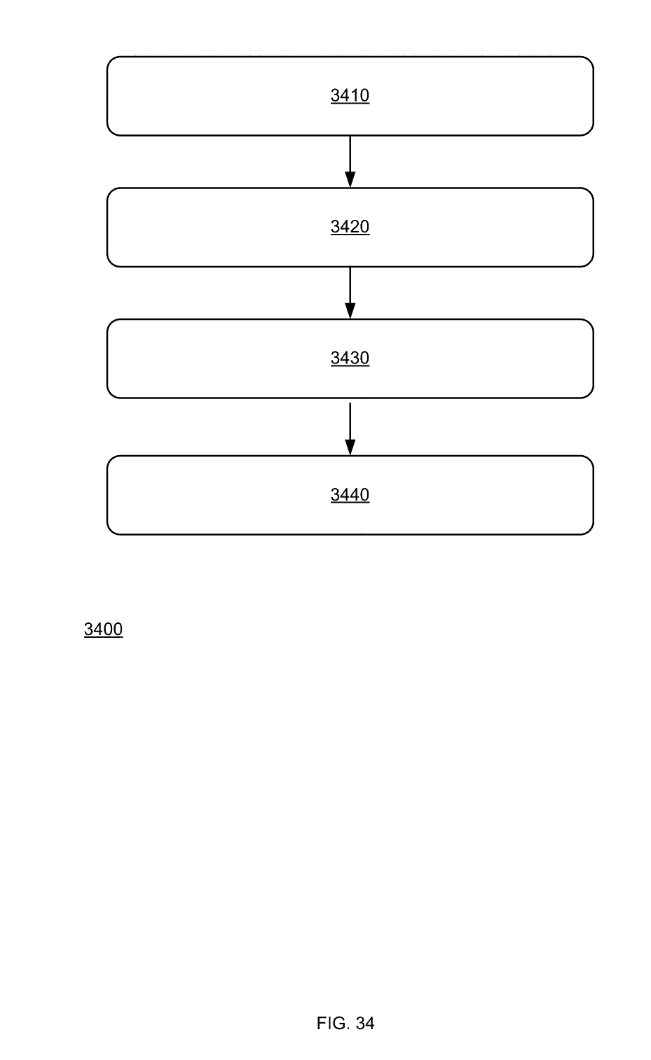

FIG. 34 illustrates a method 3400 for generating a two-dimensional fog map of a region.

Method 3400 may include a sequence of steps 3410, 3420, 3430 and 3440.

Step 3410 may include collecting the received signals levels of the commercial microwave links.

Step 3420 may include deriving commercial microwave links attenuations from the received signals levels.

Step 3430 may include deciding on an existence of fog within each of the multiple pixels based on (a) the commercial microwave links attenuations, and (b) a mapping between the commercial microwave links and the multiple pixels.

Step 3440 may include generating the two-dimensional fog map of the region by interpolating information about the at least one pixel.

Step 3440 may be responsive to information obtained by one or more other sensors that differ from microwave links.

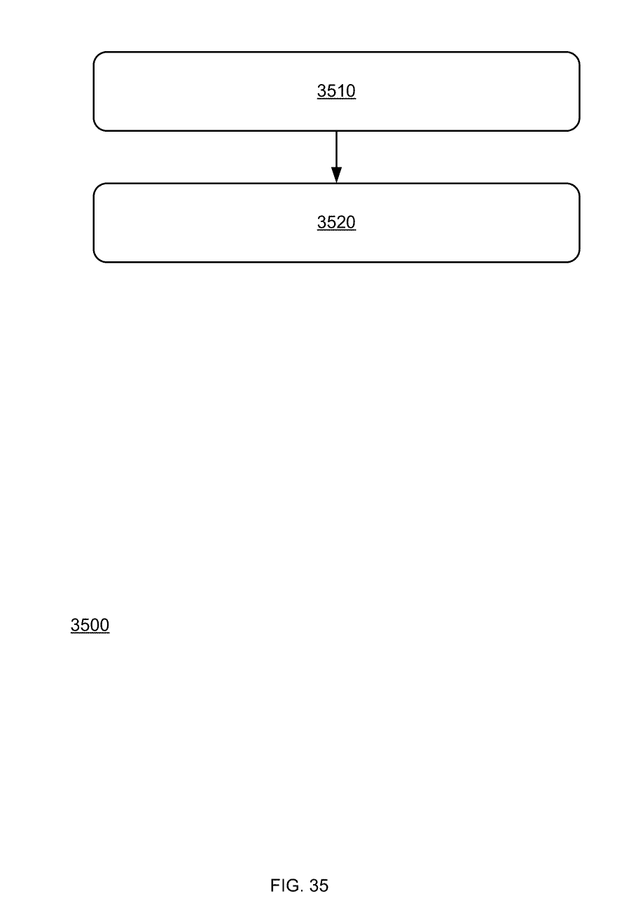

FIG. 35 illustrates a method 3500 for generating a two-dimensional fog map of a region.

Method 3500 may include a sequence of steps 3510 and 3520.

Step 3510 may include deciding on an existence of fog within at least one pixel of the multiple pixels.

Step 3520 may include generating the two-dimensional fog map of the region by interpolating information about the at least one pixel, wherein the interpolating is responsive to topography of the multiple pixels.

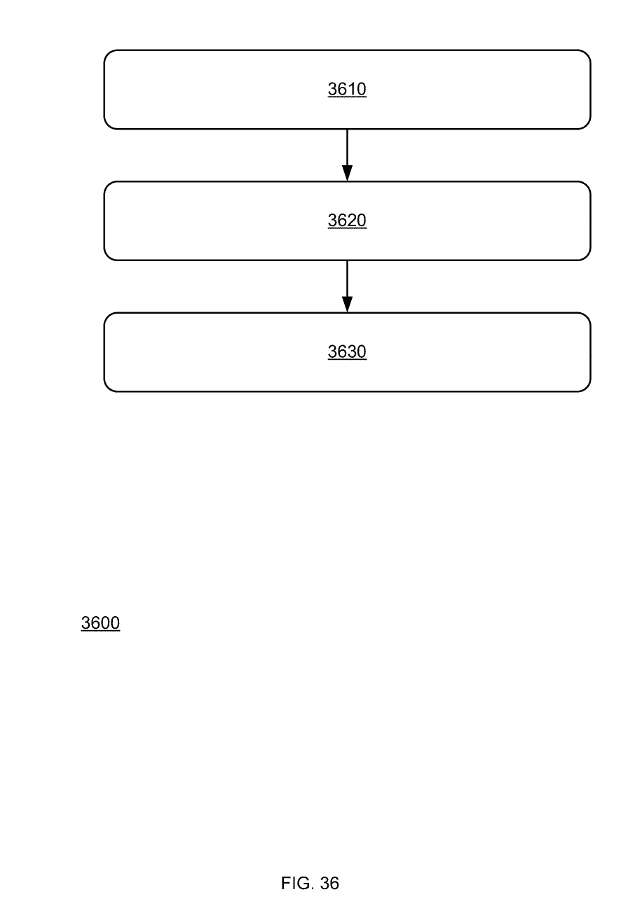

FIG. 36 illustrates a method 3600 for generating a two-dimensional fog map of a region.

Method 3600 may include a sequence of steps 3610, 3620 and 3630.

Step 3610 may include measuring by sensors, receiving or generating microwave attenuation information about attenuation of microwave communication links that are spread within multiple pixels of the region.

Step 3620 may include calculating a microwave attenuation attribute for each pixel out of a plurality of pixels of the region based on the microwave attenuation information to provide a plurality of microwave attenuation attributes. The plurality of pixels belong to the multiple pixels.

Step 3630 may include generating the two-dimensional fog map of the region based, at least in part, on the plurality of microwave attenuation attributes.

Step 3630 may include at least one of the following:
a. Calculating a fog attribute for each pixel of the plurality of pixels based on a microwave attenuation attribute of the pixel.
b. Calculating a fog attribute of a certain pixel of the multiple pixels based on at least one fog attribute of at least one other pixel of the multiple pixels.
c. Calculating the two-dimensional fog map of the region in response to additional information that differs from the plurality of microwave attenuation attributes.

The additional information may include at least one out of (i) topographic information, (ii) heights of the multiple pixels, (iii) humidity measurements, (iv) information from rain sensors, (v) satellite acquired information, (vi) wind information, and (vii) temperature information.

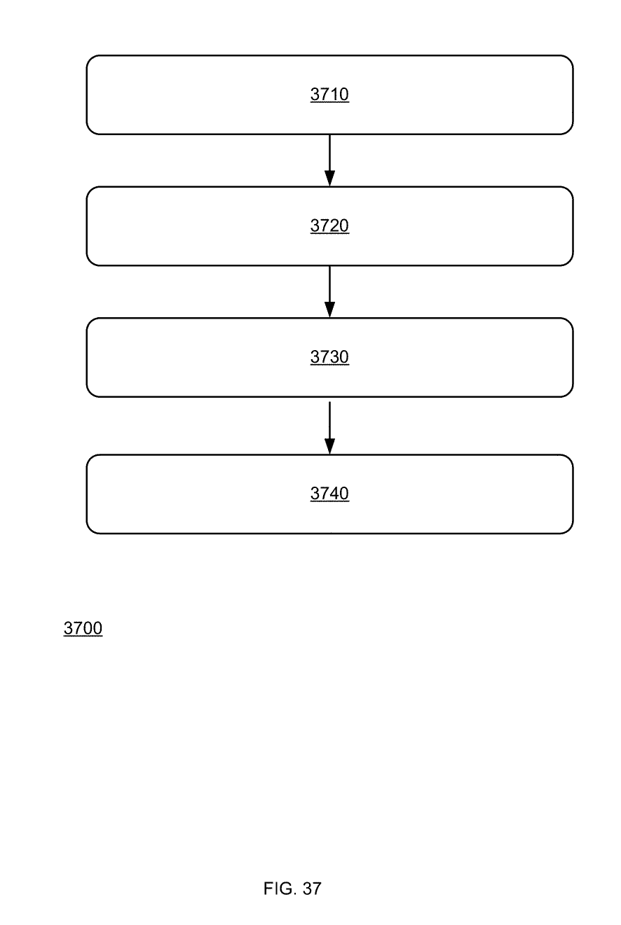

FIG. 37 illustrates a method 3700 for generating a two-dimensional fog map of a region.

Method 3700 may include a sequence of steps 3710, 3720, 3730 and 3740.

Step 3710 may include collecting measurements of received signals levels from commercial microwave links. The measuring is executed by a near-ground sensors network of the commercial microwave links. The commercial microwave links are spread within multiple pixels of the region.

Step 3720 may include deriving commercial microwave links attenuations from the received signals levels.

Step 3730 may include deciding on an existence of fog within each pixel in which measurements exist based on (a) the commercial microwave links attenuations, and (b) a mapping between the commercial microwave links and the multiple pixels.

Step 3740 may include generating the two-dimensional fog map of the region based on the existence of fog within at least one pixel of the multiple pixels.

The two-dimensional fog map of the region may be stored, transmitted to another device, displayed to a user, and the like.

Step 3740 may include interpolating information about the at least one pixel. The interpolation may be based on values of neighboring pixels of the at least one pixels.

Step 3740 may include may be responsive to information obtained by one or more other sensors that differ from microwave links sensors.

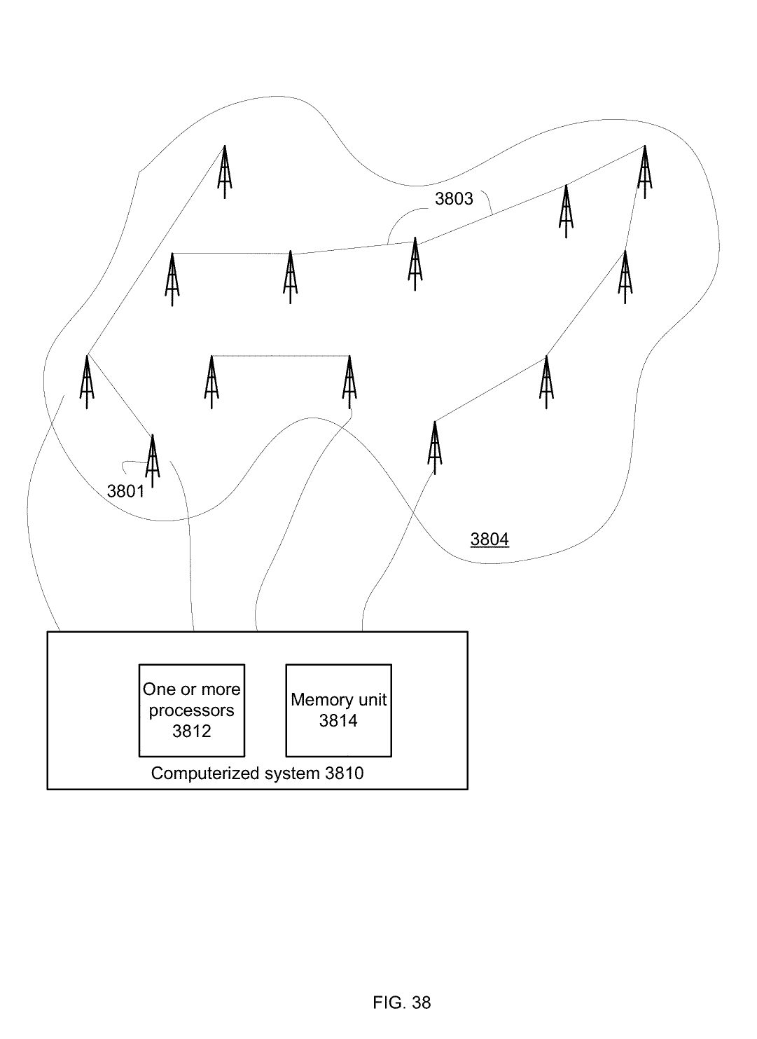

FIG. 38 illustrates a network 3804 that includes multiple microwave links that are maintained base stations 3801 the base stations include receiver and transmitters, the receivers may act as near-ground sensors) 3801, the base stations sense the amplitude of receives signals and they (or other entities may calculate the attenuation per link—by subtracting the received signals from the transmitted signals). A computerized system 3810 is coupled to the network and may include one or more processors and one or more memory units. The computerized system may be a server, multiple servers or any other computing and storage system.

The computerized system 3810 may calculate the attenuations or receive the attenuations from network 3804 or from any other entity.

Computerized system 3810 may be arranged to execute any of the methods and/or method s mentioned above.

The suggested methods show a convincing fit between fog mapping by a proprietary satellite platform, humidity gauge records and the proposed method. Differences between the techniques are expected since there is a difference in the technical nature according to which the measurements were taken: ground level sensors spread across a large area with a predefined deployment and operating frequencies, vs. sampling taken from a great distance by the satellite using frequencies and resolution specifically tailored for this purpose. Thus, future research could examine combining the different tools to achieve improved mapping capabilities.

One can note that the results of the microwave-based method obtained during the first case (FIG. 25) are more compatible with the satellite and the RH stations than the results obtained during the second fog event (FIG. 30). This is possibly due to the fact that the number of links that took the measurements during the first event was greater and, accordingly, the coverage was better.

In some areas, the microwave system detected fog, while the satellite did not identify the phenomena at that location. This may arise from several different causes. First, it is possible that the detection of the microwave system was incorrect at that specific location.

This can occur from choosing a reference RSL that is not sufficiently precise for calculating the attenuation, from the microwave system's inherent quantizing error, as well as environmental conditions such as wetness on the microwave antennas caused by condensation during periods of high RH in areas where there is no fog.

The method does approximate wet antenna attenuation and adjusts the measurements accordingly, but an insufficiently precise wet antenna approximation may cause false detection. On the other hand, there are possible cases, where the microwave system detected actual fog at a specific location in the observed area, while the satellite failed to.

This case is possible, for example, due to high altitude cloud cover which was obscuring the fog from the satellite angle of sight (FIG. 4). In other cases, the satellite may have detected fog from its vantage point where in practice it was only a low stratus cloud, which was located several tens of meters above ground level.

The technique presented in this study enables the integration of topographical data along with the microwave measurements for improved mapping. Notably, radiation fog is generated when the air cools down to the dew-point temperature. Hence, lower locations within the topography are the first to turn foggy, reaching the lowest temperatures during the night. Since the technique exploits topographical dependency for mapping fog, it can be assumed that its efficiency will be higher for mapping radiation fog and in future research, where additional cases will be examined, it will be possible to test this aspect.

In cases where additional fog monitoring instruments exist, those can be used in conjunction with the proposed method in order to improve performance. Such tools include, for example, visibility sensors, transmissometers or ceilometers. An additional future challenge is examining the ability of this method to detect fog in areas where there are no conventional methods for its detection, or decreasing the dependence on meteorological data (e.g. rain gauge records required to rule out precipitation).

Due to the severe visibility limitations associated with fog, it poses a particular danger in the aviation and ground transportation realms. However, the current means of 2D monitoring of fog often don't provide an adequate response. The technique presented here for mapping fog in space utilizing existing microwave infrastructure has the potential to provide a complementary tool for existing monitoring instruments and, potentially, to provide a response in cases where conventional fog detection instruments are non-existent.

Any reference to any of the terms “comprise”, “comprises”, “comprising” “including”, “may include” and “includes” may be applied to any of the terms “consists”, “consisting”, “and consisting essentially of”. For example—any of the rectifying circuits illustrated in any figure may include more components that those illustrated in the figure, only the components illustrated in the figure or substantially only the components illustrate din the figure.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A computerized method for generating a two-dimensional fog map of a region, the method comprises:
collecting measurements of received signals levels from commercial microwave links; wherein the measuring is executed by a near-ground sensors network of the commercial microwave links, wherein the commercial microwave links are spread within multiple pixels of the region;
deriving commercial microwave links attenuations from the received signals levels;
deciding on an existence of fog within each pixel in which measurements exist based on (a) the commercial microwave links attenuations, and (b) a mapping between the commercial microwave links and the multiple pixels; and
generating the two-dimensional fog map of the region based on the existence of fog within at least one pixel of the multiple pixels.

2. The computerized method according to claim 1 wherein the generating of the two-dimensional fog map of the region comprises interpolating information about the at least one pixel.

3. The computerized method according to claim 1 wherein the generating of the two-dimensional fog map of the region is further responsive to information obtained by one or more other sensors that differ from microwave links sensors.

4. (canceled)

5. (canceled)

6. (canceled)

7. (canceled)

8. (canceled)

9. (canceled)

10. (canceled)

11. (canceled)

12. A computer program product that stores instructions that once executed by a computerized system cause the computerized system to execute the steps of:
receiving information about commercial microwave links attenuations from received signals levels of commercial microwave links; wherein the commercial microwave links are spread within multiple pixels of a region;
deciding on an existence of fog within at least one pixel of the multiple pixels based on (a) the commercial microwave links attenuations, and (b) a mapping between the commercial microwave links and the multiple pixels; and
generating a two-dimensional fog map of the region based on the existence of fog within at least one pixel of the multiple pixels.

13. The computer program product according to claim 12 wherein the generating of the two-dimensional fog map of the region comprises interpolating information about the at least one pixel.

14. The computer program product according to claim 12 wherein the generating of the two-dimensional fog map of the region is further responsive to information obtained by one or more other sensors that differ from microwave radiation sensors.

15. (canceled)

16. (canceled)

17. A computerized system that comprises a processor, a memory unit and a near-ground sensors network of commercial microwave links;
wherein the near-ground sensors network of the commercial microwave links is configured to measure received signals levels provided by the commercial microwave links; wherein the commercial microwave links are spread within multiple pixels of a region;
wherein the processor is configured to:
derive commercial microwave links attenuations from the received signals levels;
decide on an existence of fog within at least one pixel of the multiple pixels based on (a) the commercial microwave links attenuations, and (b) a mapping between the commercial microwave links and the multiple pixels; and
generate a two-dimensional fog map of the region based on the existence of fog within at least one pixel of the multiple pixels.

18. The computerized system according to claim 17 wherein the processor is configured to generate the two-dimensional fog map of the region by interpolating information about the at least one pixel.

19. The computerized system according to claim 17 wherein the processor is configured to generate the two-dimensional fog map of the region based on information obtained by one or more other sensors that differ from microwave radiation sensors.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. The computerized method according to claim 1 wherein the deciding on an existence of fog within each pixel in which measurements exist is also based on topographic information.
